(19) United States
(12) Patent Application Publication
(10) Pub. No.: US 2026/0322774 A1
(43) Pub. Date: Oct. 15, 2026

(54) Vision-Based Communication Trigger

(71) Applicant: Shusheng Fang, Upper Saddle River, NJ (US)

(72) Inventor: Shusheng Fang, Upper Saddle River, NJ (US)

(21) Appl. No.: 19/717,722

(22) Filed: Jun. 24, 2026

Related U.S. Application Data
(63) Continuation-in-part of application No. 18/919,557, filed on Oct. 18, 2024.
Application No. 18/919,557 is a continuation of application No. 17/645,967, filed on Dec. 24, 2021, now Pat. No. 12,126,580.
Application No. 17/645,967 is a continuation-in-part of application No. 17/398,880, filed on Aug. 10, 2021, now abandoned.

(51) Int. Cl. H04L 51/046; B60W 40/10; H04L 51/58; H04W 4/46; H04W 4/80

(52) U.S. Cl. CPC H04L 51/046; B60W 40/10; H04L 51/58; H04W 4/46; H04W 4/80; B60W 2556/65

(57) ABSTRACT

A system and method are provided for establishing communications between vehicles based on visual communication identifiers (VCI). A primary vehicle may set one or more VCI corresponding to characteristics of desired secondary vehicles, such as license plate information, insignia or distinctive markings, vehicle type, etc. While operating, the primary vehicle may utilize one or more vision sensors or other sensors to detect and analyze characteristics of surrounding secondary vehicles and determine whether the detected characteristics satisfy the primary vehicle's set VCI. When a matching secondary vehicle is identified, the vehicles may execute handshake protocols including approval, authentication, compatibility, security, and preference evaluations. Upon successful completion of the handshake protocols, a transient virtual chatroom may be generated and assigned a temporary communication identifier (TCID) for managing the communication session. The primary vehicle may continue monitoring for additional secondary vehicles satisfying the set VCI while maintaining one or more active communication sessions.

### CROSS-REFERENCES TO RELATED APPLICATIONS

This Non-Provisional Utility Patent Application is a Continuation-In-Part (CIP) Application of U.S. Non-Provisional patent application Ser. No. 18/919,557, filed Oct. 18, 2024, entitled “Transient Chatrooms Adapted to Provide Communications Among Drivers,” which claims the benefit of and priority to U.S. Non-Provisional patent application Ser. No. 17/645,967 (U.S. Pat. No. 12,126,580), filed Dec. 24, 2021, entitled “Transient Chatrooms Adapted to Provide Communications Among Driver,” which is a CIP Application of U.S. Non-Provisional application Ser. No. 17/398,880, filed Aug. 10, 2021, entitled “Method and System for Provisioning Realtime Social Community Based on Location Service,” the entire contents of each application of which are hereby incorporated herein by reference.

### BACKGROUND

Conventional driver-to-driver communication is often limited to indirect visual signals, such as turn signals, brake lights, hand gestures, or other ambiguous roadway cues that may be difficult to interpret and do not provide a reliable mechanism for direct communication between specific vehicles.

### SUMMARY

A primary vehicle may set one or more VCIs (vehicle communication identifiers) to identify secondary vehicles with which communication may be desired. The VCI may include vehicle characteristics such as license plate information, vehicle color, sticker insignia or affiliations, distinctive markings, vehicle make, model, or type, vehicle size characteristics, or other characteristics associated with a secondary vehicle. The VCI may be established manually, through pre-set configurations, through AI-based determination, or combinations thereof, and may represent authorized, selected, preferred, or otherwise configured communication criteria for determining whether a communication opportunity should be initiated.

While the primary vehicle is operating, the primary vehicle may use one or more vision sensors, a vision scanner, or other sensors to detect VCI (or characteristics) associated with surrounding secondary vehicles. For example, the primary vehicle may continuously monitor nearby vehicles and analyze captured images, video, radar data, lidar data, thermal data, acoustic data, wireless data, or combinations thereof to identify characteristics of secondary vehicles. The communication application may compare the detected VCI against the set VCI of the primary vehicle to determine whether a secondary vehicle satisfies the applicable communication criteria. In some embodiments, detection of the VCI by a vision sensor or other sensor may itself indicate that the secondary vehicle is sufficiently proximate for communication purposes.

When a secondary vehicle satisfies one or more parameters of a VCI category, the primary vehicle may transmit a communication request to the secondary vehicle and execute one or more handshake protocols. The handshake protocols may include user approvals, automated approvals, authentication procedures, compatibility validations, trust evaluations, security checks, communication preference checks, and other authorization procedures. The handshake protocols may further determine whether the secondary vehicle is accepting new communication sessions, whether sufficient communication bandwidth exists, whether the communication applications are compatible, whether one or both vehicles satisfy security requirements, or whether prior interactions or user-defined restrictions should prevent the communication session.

Upon successful completion of the handshake protocols, a transient virtual chatroom may be generated for the participating vehicles. The transient virtual chatroom may be generated locally by one or more communication applications, remotely by a remote service, or through a distributed combination thereof. A TCID may also be generated and associated with the transient virtual chatroom to uniquely identify the communication session, route communications, manage participant access, maintain session state information, enforce security policies, and coordinate interactions among participating vehicles.

The primary vehicle may continue monitoring for characteristics of secondary vehicles that meet the set VCI during and after the generation of a transient virtual chatroom. Accordingly, the primary vehicle may maintain one or more active communication sessions while continuing to identify additional secondary vehicles that satisfy applicable communication criteria. Additional communication requests, handshake protocols, transient virtual chatrooms, and TCIDs may therefore be generated while existing communication sessions remain active, thereby enabling the system to dynamically identify, establish, manage, and terminate communications among vehicles based on detected VCI.

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It will be appreciated that the above-described subject matter may be implemented as a computer-controlled apparatus, a computer process, a computing system, or as an article of manufacture such as one or more computer-readable storage media. These and various other features will be apparent from reading the following Detailed Description and reviewing the associated drawings.

### BRIEF DESCRIPTION OF THE DRAWINGS

FIG. 1 shows an illustrative environment of a remote service managing vehicle-to-vehicle interactions;

FIG. 2 shows an illustrative representation of various detectable VCIs (visual communication identifiers) that may be set at a primary vehicle;

FIG. 3 shows illustrative representations of tables of specific detectable VCIs;

FIG. 4 shows an illustrative flowchart of communication sessions being generated;

FIG. 5 shows an illustrative representation of the primary vehicle generating a TCID (Temporary Communication Identifier) associated with a communication session;

FIGS. 6 and 7 show illustrative representations of a dialogue between two vehicles that satisfy various criteria;

FIG. 8 shows an illustrative representation of secondary vehicle VCI and proximity to the primary vehicle effect the generation of a communication session;

FIGS. 9A and 9B show illustrative representations of communication requests being approved or denied via handshake protocols;

FIG. 10 shows an illustrative representation of a primary vehicle scanning for VCI on secondary vehicles;

FIG. 11 shows an illustrative representation of a primary vehicle identifying and attempting to communicate with various secondary vehicles while their vehicle is active.

FIG. 12 shows an illustrative flowchart that may be performed by one or more of a primary vehicle, secondary vehicle, or remote service;

FIG. 13 is a simplified block diagram of an illustrative architecture of a computing device or on-board computer system that may be used at least in part to implement the present vision-based communication trigger; and

FIG. 14 is a simplified block diagram of an illustrative remote computing device, remote service, computing device, or on-board computing system, that may be used in part to implement the present vision-based communication trigger.

Like reference numerals indicate like elements in the drawings. Elements are not drawn to scale unless otherwise indicated.

### DETAILED DESCRIPTION

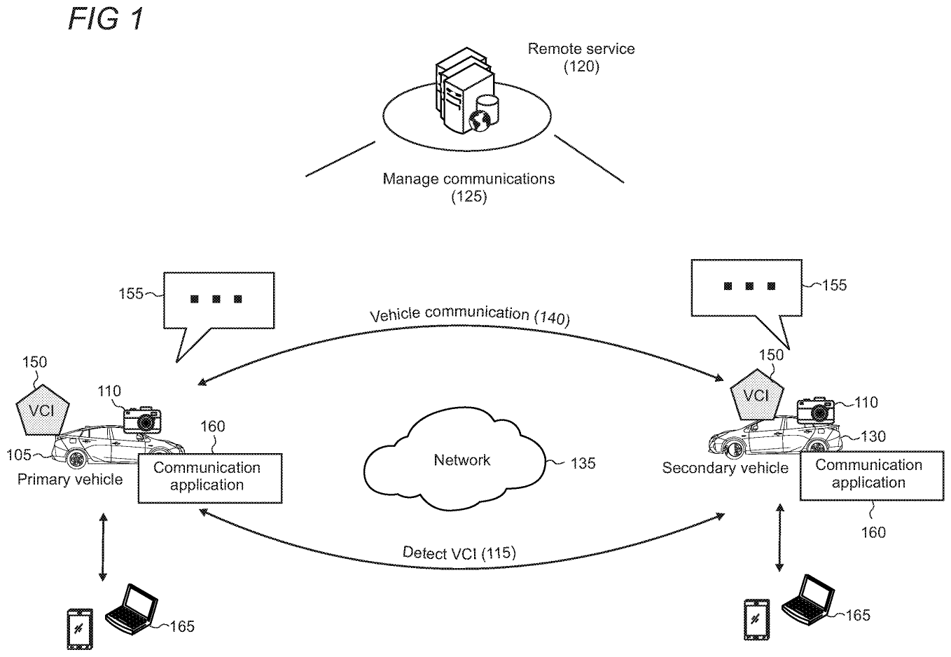

FIG. 1 shows an illustrative representation in which a primary vehicle 105, using one or more vision sensors 110, detects VCI (visual communication identifier) associated with other vehicles, representatively referred to as secondary vehicle 130. While a single secondary target vehicle is shown herein, it should be understood that the primary vehicle scans for VCI 150 on multiple vehicles within sensory proximity to secondary vehicles. Furthermore, secondary vehicles may likewise scan for other vehicles, such as the primary vehicle. Thus, any discussion of the primary vehicle's actions discussed herein can likewise apply to secondary vehicles with a similar configuration and application. Exemplary VCI 150, as discussed in greater detail below, can include any characteristics about another vehicle that can be detected with some vision sensor 110 or other sensory device, such as color, insignia, vehicle type, make, and model, license plate, etc.

VCI that satisfies some set criteria with the primary vehicle 105 may trigger that primary vehicle to initiate a conversation with the secondary vehicle 130. Depending on the handshake protocols between the primary and secondary vehicles, vehicle communications 140 may occur, which may be represented by a dedicated transient virtual chatroom 155 between those vehicles which may include other vehicles as well. Such communications may, in typical implementations, be audio-based, such as using microphones and speakers associated with each vehicle's systems. However, in some embodiments, text, may additionally or separately be used.

Such communications may be executed over network 135, which can include a local area network, a wide area network, the Internet, and the World Wide Web. Communications may occur via some direct vehicle-to-vehicle communication, such as Bluetooth®, NFC (near field communication), Wi-Fi, cellular connection, or other available mechanisms. Alternatively or additionally, connections between paired vehicles (e.g., vehicles where VCI was satisfied) may be executed over a connection with a remote service 120 that hosts the communication session. Thus, remote connections may be initiated with the remote service 120, which then hosts and manages the transient virtual chatroom 155 and communications 125. Further discussion about the establishment of chatrooms may be found in patent application Ser. No. 18/919,557, filed Oct. 18, 2024, entitled “Transient Chatrooms Adapted to Provide Communications Among Drivers,” the entire disclosure of which is hereby incorporated herein by reference.

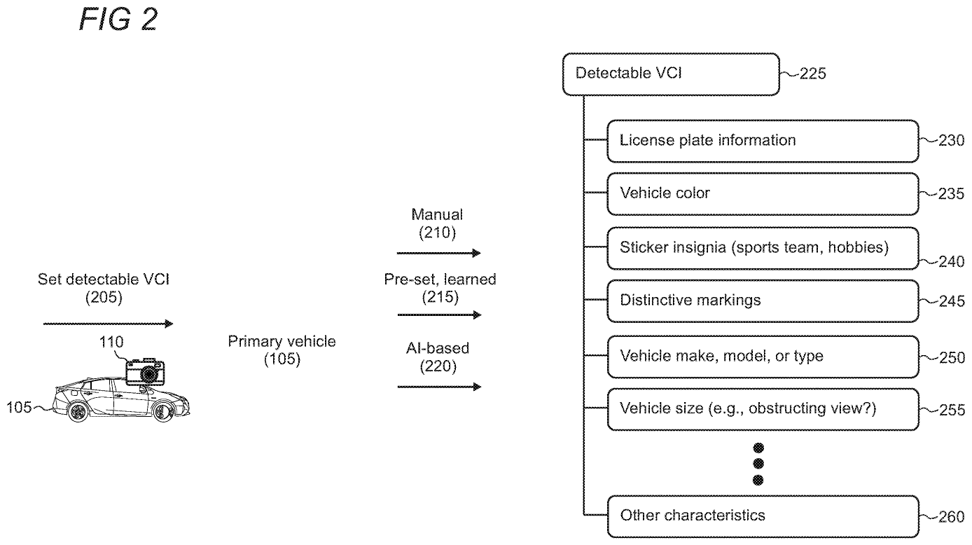

Shown in FIG. 1 are computing devices 165, which may be the devices that interoperate with vehicle components or on which the communication application 160 is instantiated. The devices may be separate from the vehicle itself, or may be part of an on-board computer system. Discussion of the operation of how the computing devices and vehicles operate can be viewed in the discussion of at least FIGS. 1 and 2 in patent application Ser. No. 18/919,557, filed Oct. 18, 2024, entitled “Transient Chatrooms Adapted to Provide Communications Among Drivers,” the entire disclosure of which is hereby incorporated herein by reference.

FIG. 2 shows an illustrative representation in which the primary vehicle 105 sets detectable visual communication identifiers (VCI) 205 that represent characteristics of secondary vehicles for purposes of initiating transient virtual chatrooms 155 and conversations with secondary vehicles 130. The detectable VCI 205 may be established manually 210, through pre-set configurations 215, or through AI-based determination 220. In some embodiments, a user of the primary vehicle 105 may manually 210 select one or more vehicle characteristics through a user interface, such as by entering desired characteristics, selecting from menus, defining filtering rules, prioritizing certain vehicle attributes, or otherwise specifying the types of secondary vehicles with which the user desires to communicate. For example, the user may elect to communicate with vehicles displaying particular sports team affiliations, vehicles of a particular make or model, electric vehicles, commercial vehicles, emergency vehicles, or vehicles displaying other user-selected attributes.

In some embodiments, the detectable VCI 205 may be established through one or more pre-set configurations 215. The pre-set configurations may comprise manufacturer-defined settings, user-created profiles, downloadable profiles, location-specific profiles, event-specific profiles, or other predefined criteria. For example, a user traveling to a sporting event may activate a pre-set profile configured to identify vehicles displaying the same team affiliation. Similarly, a commuting profile may prioritize identification of nearby commuters, carpool participants, or vehicles traveling along a common route. Multiple pre-set profiles may be stored and selectively activated based upon time, location, destination, calendar events, vehicle mode, or other triggering conditions.

In further embodiments, detectable VCI 205 may be established through AI-based determination 220. The AI-based determination may utilize machine learning models, neural networks, behavioral analysis engines, recommendation engines, predictive analytics, or other artificial intelligence techniques to identify vehicle characteristics that are likely to be relevant to the user. The AI system may analyze historical interactions, prior chatroom participation, accepted or rejected communication requests, driving habits, navigation history, user preferences, social media associations, demographic information, event attendance history, or behaviors of similar users to automatically generate, modify, prioritize, or recommend detectable VCI. For example, the AI system may learn that a user frequently initiates conversations with owners of certain vehicle types, attendees of specific events, fans of particular sports teams, members of automotive clubs, or vehicles associated with similar destinations, and may automatically adjust the detectable VCI accordingly. The AI system may further adapt the detectable VCI in real time based upon changing environmental conditions, vehicle density, current location, ongoing events, or recent interaction success rates.

As illustrated, detectable VCI 225 may include license plate information 230, vehicle color 235, sticker insignia or affiliations 240 such as sports teams, hobbies, organizations, schools, charities, political campaigns, or professional associations, distinctive markings 245, and vehicle make, model, or type 250. Detectable VCI 225 may further include vehicle size characteristics 255, such as whether a vehicle is a truck, sport utility vehicle, motorcycle, commercial vehicle, recreational vehicle, oversized vehicle, or other vehicle classification. Such characteristics may be detected through cameras, computer vision systems, optical character recognition systems, sensors, wireless communications, third-party databases, user-provided information, or combinations thereof.

In some embodiments, other characteristics 260 and additional VCI may be utilized to facilitate matching and transient virtual chatroom creation. Such VCI may include vehicle age, vehicle trim package, manufacturer-installed options, aftermarket modifications, wheel types, vehicle condition, vehicle occupancy levels, roof racks, cargo carriers, trailer attachments, commercial branding, company logos, dealership markings, vanity license plates, temporary tags, state or country of registration, vehicle registration class, vehicle ownership category, autonomous driving capability, electric vehicle status, charging state, fuel type, route similarity, destination similarity, travel speed, travel direction, convoy participation, fleet membership, rideshare status, delivery status, emergency response status, public transportation status, accessibility-related designations, and combinations thereof.

Additional VCI may also include contextual and behavioral characteristics associated with a vehicle or its occupants. For example, the VCI may represent attendance at a common event, participation in a common organization, membership in a club, frequent visitation of common locations, shared commuting routes, common travel destinations, participation in a caravan, similarity of navigation paths, participation in charitable events, educational affiliations, military affiliations, professional affiliations, recreational interests, music preferences, shopping preferences, social media affiliations, or other inferred characteristics. In some embodiments, such characteristics may be determined through vehicle sensors, onboard computing devices, connected mobile devices, navigation systems, wireless communications, cloud-based services, third-party databases, artificial intelligence systems, or combinations thereof to identify vehicles that are likely to share a common interest, purpose, destination, or topic of conversation.

In some examples, the primary vehicle may utilize one or more sensors other than vision sensors 110 to detect, identify, characterize, or otherwise determine VCI associated with a secondary vehicle. For example, the primary vehicle may include radar sensors configured to detect the presence, location, speed, acceleration, heading, size, and relative movement of nearby vehicles. Radar data may be analyzed to determine whether a detected object is a passenger vehicle, commercial truck, motorcycle, bus, emergency vehicle, construction vehicle, trailer, or other vehicle type. In some embodiments, radar signatures associated with particular vehicle classes, dimensions, movement profiles, or configurations may be used as VCI for determining whether communication with a detected secondary vehicle would be beneficial.

Additionally, the primary vehicle may include lidar sensors configured to generate three-dimensional representations of nearby vehicles and surrounding objects. Lidar data may be processed to identify characteristics such as vehicle dimensions, body style, cargo configurations, trailer attachments, roof-mounted equipment, bicycle racks, ladders, specialized commercial equipment, or other physical features. Such information may be utilized as VCI to determine similarities, shared interests, operational relevance, or other communication criteria. For example, the detection of similar vehicle models, fleet vehicles, recreational vehicles, towing vehicles, or vehicles carrying specialized equipment may increase the likelihood that a communication session should be established.

In some embodiments, acoustic sensors, microphones, vibration sensors, or other sound-detection systems may be utilized to identify characteristics of nearby vehicles. For example, acoustic data may be analyzed to detect engine types, engine displacement ranges, electric vehicle operation, emergency sirens, construction equipment, exhaust profiles, tire noise characteristics, warning signals, horns, or other audible indicators. The detected acoustic characteristics may form part of the VCI utilized when determining whether a communication opportunity exists between the primary vehicle and the secondary vehicle.

The primary vehicle may further include thermal sensors, infrared sensors, or other heat-detection devices configured to identify characteristics of nearby vehicles. For example, thermal signatures may indicate whether a vehicle is actively operating, carrying heavy cargo, towing a trailer, utilizing refrigeration equipment, operating specialized machinery, experiencing overheating conditions, or otherwise exhibiting characteristics relevant to communication establishment. Thermal data may also assist in distinguishing between different vehicle classes or operational states.

In some examples, wireless detection systems may additionally be utilized. For example, the primary vehicle may detect wireless transmissions, beacon signals, cellular communications, Wi-Fi communications, Bluetooth communications, ultra-wideband (UWB) signals, dedicated short-range communications (DSRC), cellular vehicle-to-everything (C-V2X) communications, or other wireless identifiers transmitted by nearby vehicles. Information derived from such communications may include vehicle make, model, manufacturer, fleet affiliation, vehicle capabilities, vehicle category, software version, destination information, route information, service affiliations, or user-defined preferences. Such information may supplement or independently serve as VCI for determining whether communication between vehicles should be established.

In some embodiments, data obtained from multiple sensor modalities may be combined through a sensor fusion process. For example, radar data, lidar data, thermal data, acoustic data, wireless data, and vision data may be analyzed together to generate a more comprehensive VCI profile for a detected secondary vehicle. The sensor fusion process may increase confidence levels associated with detected vehicle characteristics, resolve ambiguities between sensor outputs, identify vehicles under adverse weather or lighting conditions, and improve the accuracy of determining whether a communication channel, transient chat room, information exchange session, or other interaction should be established between the primary vehicle and the secondary vehicle.

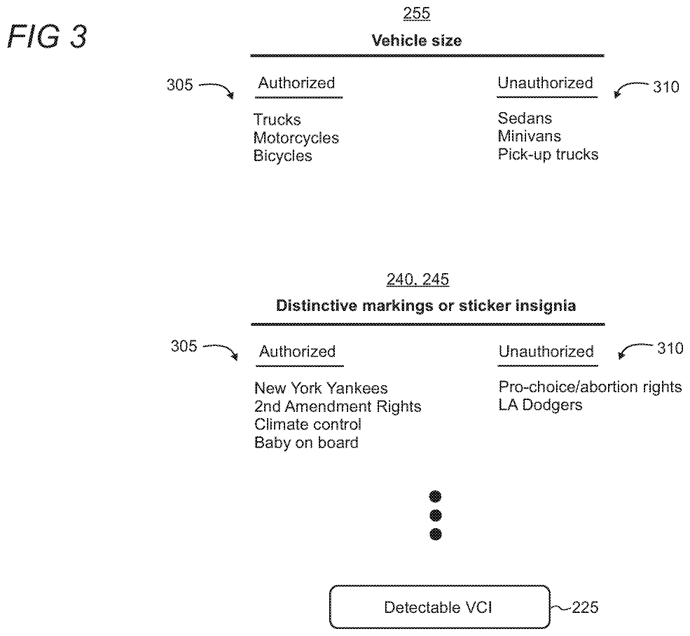

FIG. 3 shows an illustrative representation of one or more data tables in which detectable visual communication identifiers 225 are categorized and selectively designated as authorized 305 for communications or unauthorized 310 for communications. In some embodiments, the authorized and unauthorized designations may be established manually by a user, selected from one or more pre-set profiles, generated by an artificial intelligence (AI) engine, or combinations thereof. The designations may be utilized by the system to determine whether a transient virtual chatroom 155 should be initiated, whether a communication request should be transmitted, whether incoming communication requests should be accepted, or otherwise control interactions between the primary vehicle 105 and one or more secondary vehicles 130.

In the illustrated example, vehicle size 255 is provided as a VCI category having a subset list of authorized VCI 305 and unauthorized VCI 310. Authorized VCI 305 for vehicle size 255 may include trucks, motorcycles, bicycles, sport utility vehicles, commercial vehicles, recreational vehicles, or other vehicle classifications. Unauthorized VCI 310 may include sedans, minivans, pick-up trucks, compact vehicles, or other vehicle classifications that the user does not wish to engage. Thus, when the system detects a secondary vehicle having an authorized vehicle size characteristic, the system may permit, recommend, prioritize, or automatically initiate a communication session, while communications associated with unauthorized vehicle size characteristics may be blocked, filtered, deprioritized, or otherwise restricted.

In a further example, distinctive markings 245 and/or sticker insignia 240 are provided as another VCI category having authorized VCI 305 and unauthorized VCI 310. Authorized VCI 305 may include insignia, logos, messages, or markings associated with the New York Yankees®, Second Amendment rights, climate control initiatives, “baby on board” indicators, charitable organizations, educational institutions, hobbies, recreational activities, or other user-selected affiliations. Unauthorized VCI 310 may include insignia, logos, messages, or markings associated with pro-choice or abortion rights advocacy, LA Dodgers® affiliations, competing organizations, rival sports teams, conflicting interests, or other categories selected by the user. In this manner, the system may selectively enable communications with vehicles that are more likely to share common interests, viewpoints, affiliations, experiences, or destinations while reducing or eliminating communications with vehicles possessing characteristics that are not desired by the user.

Although FIG. 3 illustrates vehicle size 255 and distinctive markings or sticker insignia 240, 245 as example categories, similar authorized and unauthorized lists may be generated for any detectable VCI 225 described with respect to FIG. 2. For example, authorized and unauthorized parameters may be established for license plate information 230, vehicle color 235, vehicle make, model, or type 250, vehicle age, aftermarket modifications, state of registration, commercial branding, route similarity, destination similarity, event participation, club memberships, professional affiliations, social affiliations, autonomous vehicle capabilities, electric vehicle status, travel direction, or any other detectable vehicle characteristic identifier. In some embodiments, multiple VCI categories may be combined using Boolean logic, weighted scoring algorithms, ranking systems, or AI-generated preference models to determine whether communications should be initiated, recommended, prioritized, restricted, or blocked.

Although FIG. 3 illustrates both authorized VCI 305 and unauthorized VCI 310 categories, expressly identifying unauthorized VCI 310 is not required. In some embodiments, a user may simply specify one or more authorized, desired, or selected visual communication identifier (VCI) within a particular category, and the system may infer that vehicle characteristics not included within the specified list are not eligible for communications, are lower priority, or otherwise do not satisfy the communication criteria. For example, a user may specify that communications are desired with motorcycles and bicycles within the vehicle size category 255 without expressly identifying sedans, minivans, or other vehicle types as unauthorized. Accordingly, the unauthorized VCI 310 category is provided as one illustrative implementation, and other implementations may utilize only selected, preferred, authorized, prioritized, or positively identified VCI without requiring a corresponding list of unauthorized vehicle characteristics.

In further embodiments, the system may dynamically determine non-selected or unauthorized vehicle characteristics based on the absence of a characteristic from a selected list, threshold scoring criteria, learned user preferences, AI-generated recommendations, historical interactions, or combinations thereof. Thus, communications may be filtered, prioritized, recommended, initiated, restricted, or blocked without requiring the user to expressly define both authorized and unauthorized vehicle characteristic identifiers.

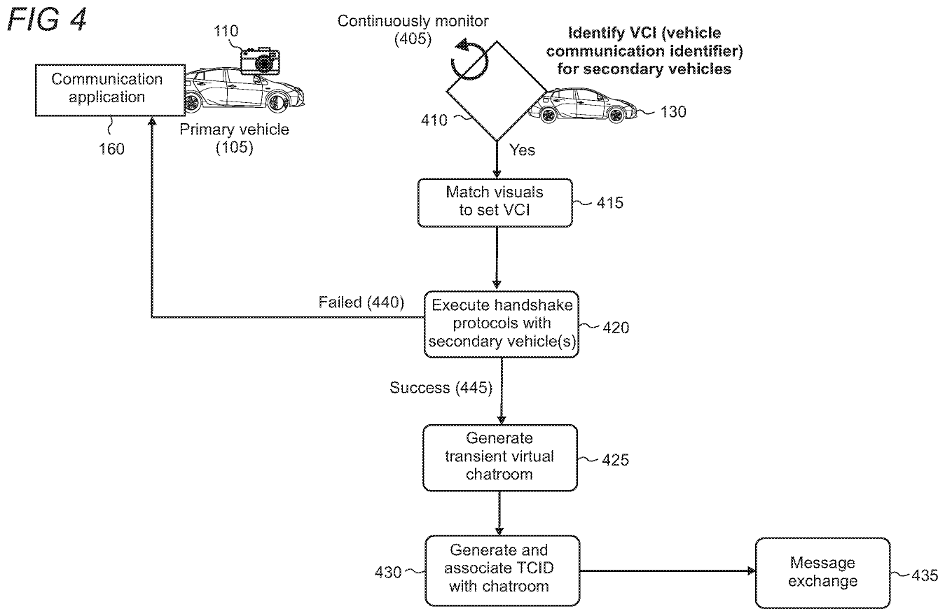

FIG. 4 shows an illustrative representation of a workflow in which the system continuously monitors 405 for detectable visual communication identifier (VCI) associated with secondary vehicles 130 that may be candidates for communication with the primary vehicle 105. In some embodiments, the monitoring may be performed continuously, periodically, event-triggered, or based on user activation. The monitoring may utilize one or more cameras, sensors, communication interfaces, mobile devices, onboard vehicle systems, or combinations thereof to identify nearby vehicles and their associated characteristics.

In step 410, the primary vehicle 105, utilizing the communication application 160, identifies one or more detectable VCI associated with nearby secondary vehicles 130. As discussed above, the VCI may include license plate information, vehicle color, vehicle make or model, vehicle size, distinctive markings, sticker insignia, route information, destination information, affiliations, or other detectable vehicle characteristics. The VCI may be determined through computer vision techniques, optical character recognition, artificial intelligence analysis, wireless communications, third-party databases, user-provided information, or combinations thereof.

In step 415, the communication application 160 compares the detected VCI against one or more selected, authorized, preferred, or otherwise configured VCI criteria, such as those described with respect to FIGS. 2 and 3. The comparison may include exact matching, partial matching, weighted scoring, ranking algorithms, threshold analysis, artificial intelligence evaluation, or combinations thereof. If the detected VCI satisfies the applicable communication criteria, the workflow may proceed to establish a communication session.

In step 420, the primary vehicle 105 and the secondary vehicle 130 perform a handshake protocol to determine whether a communication session should be established. In some embodiments, the handshake protocol may include the transmission of a communication request from the primary vehicle to the secondary vehicle, a response from the secondary vehicle indicating acceptance, rejection, or conditional acceptance, and one or more verification procedures. For example, the handshake protocol may determine whether the secondary vehicle is currently accepting new communication sessions, whether the secondary vehicle user approves the requested communication, whether the communication applications are compatible, whether sufficient communication bandwidth exists, whether the users possess compatible communication preferences, or whether one or both vehicles satisfy security requirements.

The handshake protocol may further include authentication procedures, user verification procedures, encryption key exchanges, trust score evaluations, account validation checks, reputation analysis, subscription status verification, parental control restrictions, content restrictions, geographic restrictions, or other eligibility determinations. In some embodiments, communication requests may be denied based upon insufficient security credentials, lack of user verification, prior blocking activity, previous negative interactions between users, user-defined restrictions, regulatory requirements, or other factors. Accordingly, the handshake protocol may serve as a filtering, authentication, authorization, and compatibility mechanism before a communication session is established.

A failed handshake protocol 440 would cause the primary vehicle to continue monitoring and identifying VCI on secondary vehicles. Upon successful completion of the handshake protocol 445, in step 425, the primary vehicle 105 or remote service 120 generates a communication session in the form of a transient virtual chatroom 155. The transient virtual chatroom may be generated by the communication application 160 executing locally on one or more participant vehicles, by the remote service 120, or by a combination thereof. The transient virtual chatroom may provide a dedicated communication environment through which participating vehicles and associated user devices may exchange information.

In step 430, a temporary communication identifier (TCID) is generated for the transient virtual chatroom. The TCID uniquely identifies the communication session and may be utilized for routing communications, managing participant access, maintaining session state information, storing communication records, enforcing security policies, and coordinating interactions among participating vehicles. In some embodiments, the TCID may be generated by the local communication application 160, by the remote service 120, or through a cooperative process between the local communication applications and the remote service. Where generated locally, the TCID may be synchronized with the remote service 120 to ensure uniqueness across the communication platform and to maintain centralized records of active and historical communication sessions.

Finally, in step 435, the participating vehicles exchange communications through the transient virtual chatroom 155. Such communications may include text messages, voice communications, audio clips, images, video content, vehicle-generated signals, navigation information, alerts, status updates, invitations, recommendations, reactions, emojis, or other forms of data. The communication session may persist while predefined conditions are satisfied, such as geographic proximity, mutual participation, active user engagement, route similarity, event participation, or other session criteria. Upon expiration of the applicable conditions, the transient virtual chatroom may be terminated, archived, suspended, or otherwise managed by the communication application 160 and/or remote service 120

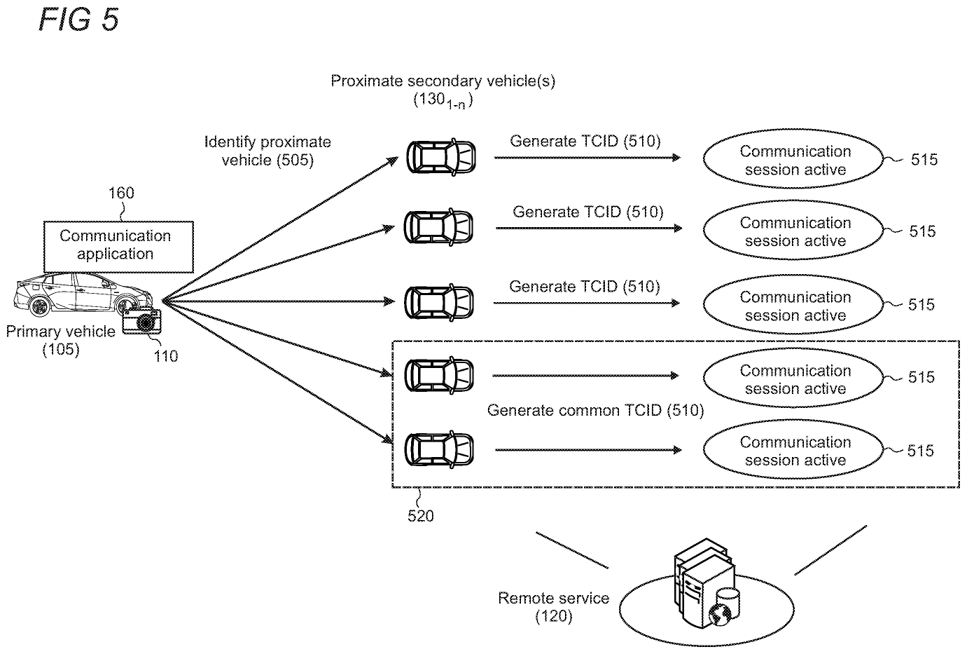

FIG. 5 shows an illustrative representation in which the primary vehicle 105 identifies one or more proximate secondary vehicles 130, as represented by reference numeral 505, and generates and associates a temporary communication identifier (TCID) 510 with a communication session. In some embodiments, the primary vehicle 105 may continuously monitor for nearby secondary vehicles 130 that satisfy one or more detectable visual communication identifier (VCI) criteria and may selectively initiate communication opportunities with such vehicles. The generated TCID 510 may uniquely identify a corresponding transient virtual chatroom 155 and may be utilized for session management, communication routing, participant authentication, message synchronization, security controls, logging, and other communication-related functions.

As illustrated, the primary vehicle 105 may participate in multiple communication sessions simultaneously. Accordingly, the primary vehicle may be actively searching for additional secondary vehicles while concurrently generating, joining, maintaining, and terminating multiple transient virtual chatrooms 155. Each communication session may be associated with a unique TCID 510, thereby allowing the communication application 160 and/or remote service 120 to independently manage multiple ongoing conversations involving different participants, topics, destinations, interests, or communication purposes.

Portion 520 illustrates an embodiment in which a common TCID 510 is generated and transmitted to two or more secondary vehicles 130. In such embodiments, the transient virtual chatroom 155 may initially be created as a multi-participant communication session rather than a one-to-one communication session. The handshake protocols discussed above with respect to FIG. 4 may be executed independently for each prospective participant vehicle. For example, the primary vehicle 105 may transmit communication requests associated with the common TCID 510 to multiple secondary vehicles 130, after which each secondary vehicle may independently determine whether to accept, reject, or otherwise respond to the communication request. Secondary vehicles that successfully complete the handshake process may be admitted into the transient virtual chatroom 155 associated with the common TCID, while vehicles that fail authentication, decline participation, fail compatibility checks, do not satisfy security requirements, or otherwise do not qualify may be excluded from the communication session.

Accordingly, a single transient virtual chatroom 155 may be generated before all participants are identified or admitted into the session. As additional secondary vehicles satisfy the applicable handshake, authorization, and communication criteria, such vehicles may be dynamically added to the chatroom associated with the common TCID. Similarly, participants may leave, be removed, lose connectivity, or otherwise become disassociated from the communication session while the remaining participants continue communicating through the same transient virtual chatroom. In this manner, the system supports dynamic creation and management of multi-vehicle communication sessions involving two, three, four, or any number of participating vehicles and associated user devices.

In some embodiments, the transient virtual chatroom 155 and corresponding TCID 510 may be generated locally by one or more communication applications 160 executing on the participating vehicles. For example, the communication application 160 of the primary vehicle 105 may generate the TCID 510, create the transient virtual chatroom 155, and transmit the TCID and associated session information to the communication applications 160 of the participating secondary vehicles 130 during the handshake process. The participating communication applications may thereafter utilize the shared TCID to route messages, authenticate participants, synchronize session data, and maintain the communication session. In certain embodiments, one of the participating vehicles may act as a host vehicle responsible for managing participant membership, communication permissions, session state information, and termination of the transient virtual chatroom.

In other embodiments, the transient virtual chatroom 155 and TCID 510 may be generated by the remote service 120. For example, following successful completion of one or more handshake protocols, the communication applications 160 may transmit participant information, detected VCI, authentication data, location information, or other session-related information to the remote service 120. The remote service may then generate a unique TCID 510, establish the transient virtual chatroom 155, maintain participant records, manage message routing, enforce security policies, and coordinate communications among the participating vehicles and associated user devices. In some embodiments, the remote service 120 may further monitor active sessions, store communication metadata, facilitate participant additions or removals, and ensure that generated TCIDs remain unique across the communication platform.

In further embodiments, generation of the transient virtual chatroom 155 and TCID 510 may be distributed between the local communication applications 160 and the remote service 120. For example, a local communication application may initially generate a provisional or temporary TCID to facilitate rapid communication establishment between nearby vehicles. The provisional TCID may subsequently be synchronized with, validated by, or replaced by a globally unique TCID generated by the remote service 120. Similarly, aspects of session creation, participant management, message routing, encryption, authentication, and logging may be performed locally, remotely, or through a hybrid arrangement. Accordingly, generation and management of the transient virtual chatroom 155 and corresponding TCID 510 may occur locally, remotely, or through any combination of distributed communication resources.

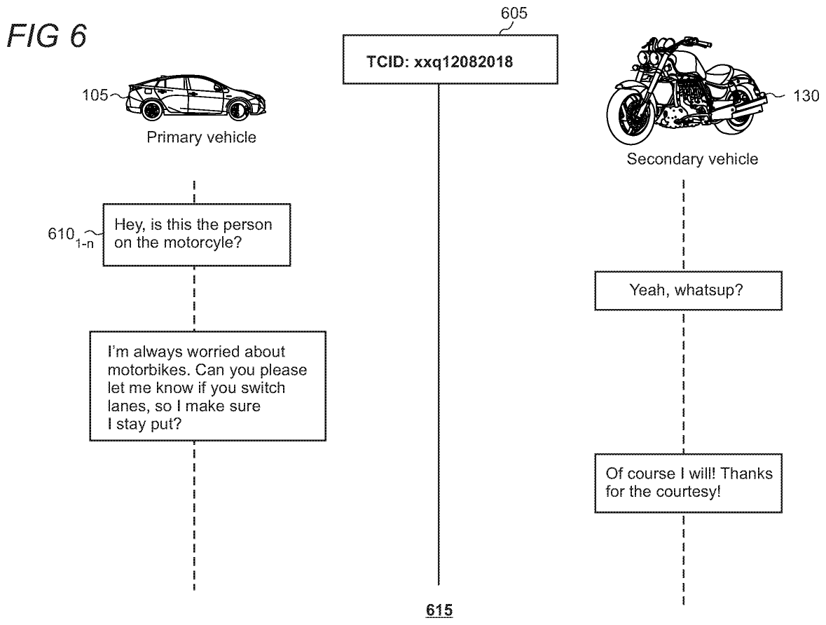

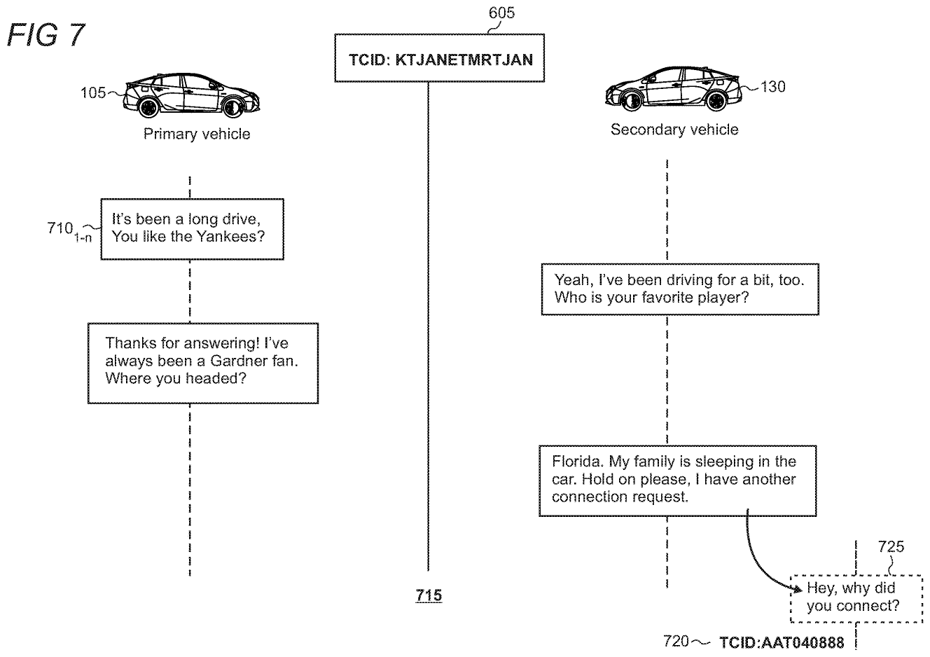

FIGS. 6 and 7 show illustrative representations of active communication sessions 615, 715 occurring within respective transient virtual chatrooms 155. As discussed above, each transient virtual chatroom 155 may be associated with a unique temporary communication identifier (TCID) that enables participant management, message routing, authentication, session tracking, and other communication functions. The illustrated communications are provided as non-limiting examples of how the disclosed VCI.

Referring first to FIG. 6, the primary vehicle 105 identifies a secondary vehicle 130 using one or more vision sensors 110 and associated vehicle detection systems. In the illustrated example, the identified secondary vehicle 130 is a motorcycle. In some embodiments, motorcycles may be included within the primary vehicle's selected or authorized VCI criteria due to safety considerations, increased accident risk, visibility concerns, lane-sharing situations, or other vehicle awareness objectives. Accordingly, detection of the motorcycle may cause the communication application 160 to initiate a communication session 615 and generate the associated transient virtual chatroom 155. As illustrated, the communication session may be utilized to exchange safety-related information between the drivers, such as intended lane changes, traffic conditions, road hazards, planned turns, vehicle positioning, visibility concerns, emergency situations, or other information that may assist the drivers in avoiding collisions or otherwise improving roadway safety. In the illustrated example, the primary vehicle driver expresses a desire to remain aware of the motorcycle's movements while driving, thereby facilitating safer operation of both vehicles.

Referring to FIG. 7, the communication session 715 within the transient virtual chatroom 155 is established based upon a different detectable VCI. In this example, the primary vehicle 105 previously configured a detectable VCI corresponding to New York Yankees insignia, logos, stickers, decals, apparel, or other identifiable markings associated with the New York Yankees. Upon detecting the corresponding insignia on the secondary vehicle 130, the communication application 160 initiates the communication session 715 and generates the associated transient virtual chatroom 155. The communication session may enable the drivers to discuss a shared interest, such as sports, entertainment, current events, travel plans, hobbies, or other topics. As illustrated, the communication may also provide safety benefits. For example, one or more participants may indicate that they have been driving for an extended period of time, are experiencing fatigue, or desire social interaction to maintain alertness while driving. By facilitating communication among occupants of nearby vehicles, the system may help reduce driver fatigue, improve attentiveness, and potentially reduce accident risks associated with drowsy driving.

FIG. 7 further illustrates that a vehicle may simultaneously participate in multiple independent communication sessions. As shown, the secondary vehicle 130 receives an additional connection request associated with a tertiary vehicle (not shown). In response, a separate communication session and corresponding transient virtual chatroom 155 may be generated. The additional communication session is assigned a new, unique, and distinct TCID 720 that differs from the TCID associated with communication session 715. Accordingly, the secondary vehicle 130 may participate in multiple transient virtual chatrooms simultaneously while maintaining separation between conversations, participants, permissions, and communication data associated with each session. As illustrated by communication box 725, a participant may inquire regarding the basis for the connection request, such as asking why the tertiary vehicle initiated communication. In response, the system may provide information regarding the detected VCI, common interests, shared destinations, common affiliations, matching communication criteria, mutual contacts, event participation, or other factors that resulted in creation of the communication session. In this manner, participants may better understand the basis for the connection request and determine whether continued participation in the transient virtual chatroom is desired.

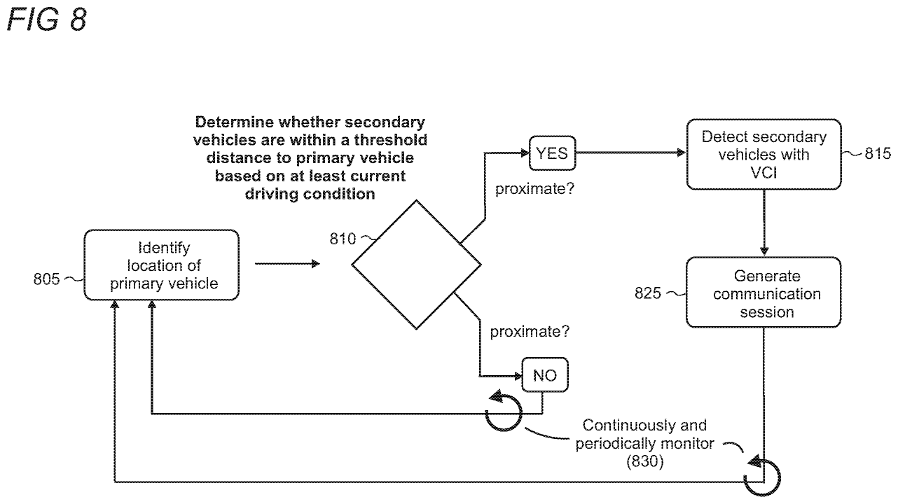

FIG. 8 shows an illustrative flowchart of an exemplary workflow in which vehicle proximity is evaluated before VCI matching and communication session generation. In some embodiments, the workflow may be executed continuously, periodically, upon user request, or in response to one or more triggering events. The illustrated workflow enables the system to first identify vehicles that are sufficiently proximate to the primary vehicle 105 before performing more detailed VCI analysis and communication-related operations.

In step 805, the primary vehicle 105 identifies its current location. In some embodiments, the location may be determined using a global positioning system (GPS), global navigation satellite systems (GNSS), cellular triangulation, vehicle navigation systems, roadside infrastructure, wireless beacons, dead reckoning systems, inertial sensors, mapping services, or combinations thereof. The location information may be continuously or periodically updated to reflect movement of the primary vehicle and to facilitate identification of nearby vehicles that may qualify for communication.

In step 810, the communication application 160 determines whether one or more secondary vehicles 130 are located within a threshold distance of the primary vehicle 105. The threshold distance may be dynamically adjusted based on one or more driving conditions, environmental factors, vehicle characteristics, user preferences, or system settings. For example, the threshold distance may be increased when the vehicles are traveling on highways, expressways, or other high-speed roadways to account for higher vehicle speeds and increased separation distances. Conversely, the threshold distance may be reduced in city streets, residential neighborhoods, parking facilities, or other lower-speed environments where vehicles are naturally located closer together.

The threshold distance may further be adjusted based upon the speed of the primary vehicle, the speed of nearby vehicles, relative vehicle velocities, traffic density, traffic flow patterns, road classifications, weather conditions, visibility conditions, time of day, road construction activity, accident conditions, or combinations thereof. For example, a greater threshold distance may be utilized when vehicles are traveling at elevated speeds, while a shorter threshold distance may be utilized during stop-and-go traffic. Similarly, the threshold distance may vary depending upon whether the vehicle is operating in an urban environment, a suburban environment, a rural environment, a mountainous region, a tunnel, a bridge, a parking area, a special event location, or another geographic setting. In some embodiments, artificial intelligence systems may dynamically adjust the threshold distance based on historical communication success rates, driver preferences, vehicle density, roadway characteristics, or predicted interaction opportunities.

If no qualifying secondary vehicles are identified within the threshold distance, the workflow proceeds to step 830, where the system continues monitoring for updated location information and nearby vehicles. The monitoring process may occur continuously or at periodic intervals to account for changing vehicle positions and driving conditions. The workflow may then return to step 805 to repeat the location determination process.

If one or more secondary vehicles are determined to be within the threshold distance, the workflow proceeds to step 815. In step 815, one or more vision sensors 110 associated with the primary vehicle 105 may detect and analyze the nearby secondary vehicles. The communication application 160 may identify one or more detectable VCI associated with the secondary vehicles and determine whether the detected VCI satisfy one or more communication criteria, preferences, filters, authorized VCI parameters, or other settings, such as those discussed above with respect to FIGS. 2 and 3. The VCI analysis may utilize computer vision techniques, optical character recognition, machine learning models, artificial intelligence systems, external databases, wireless communications, or combinations thereof.

If one or more secondary vehicles satisfy the applicable VCI criteria, the workflow proceeds to step 825. In step 825, a communication session may be generated between the participating vehicles, as discussed above. Generation of the communication session may include execution of one or more handshake protocols, creation of a transient virtual chatroom 155, generation and association of a temporary communication identifier (TCID), participant authentication, establishment of communication permissions, session configuration, message routing setup, encryption configuration, and other communication-related operations. The communication session may be established locally by the communication applications 160, remotely by the remote service 120, or through a combination thereof.

Following the generation of the communication session, the workflow proceeds to step 830. Even while one or more communication sessions remain active, the communication application 160 may continue monitoring for additional secondary vehicles that satisfy the proximity and VCI criteria. Accordingly, the primary vehicle 105 may simultaneously maintain existing communication sessions while identifying new communication opportunities. The workflow may continuously cycle through steps 805-830 to dynamically identify nearby vehicles, establish additional transient virtual chatrooms, update active communication sessions, and manage communications among participating vehicles.

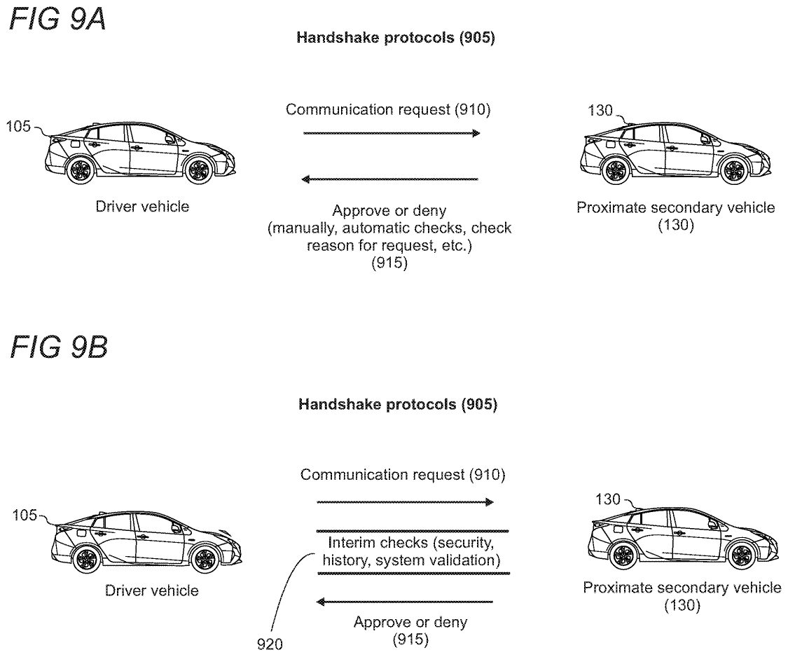

FIGS. 9A and 9B show exemplary handshake protocols 905 that may be executed between two vehicles once the primary vehicle 105 attempts to establish a communication session with one or more secondary vehicles 130. In FIGS. 9A and 9B, the handshake protocol may begin when the primary vehicle 105 transmits a communication request 910 to the secondary vehicle 130. The communication request may include, for example, a temporary communication identifier (TCID), information regarding the detected VCI that triggered the request, participant information, authentication information, location information, communication preferences, or other session-related data.

In FIG. 9A, the handshake protocol 905 may primarily rely upon an approval or denial action 915 by the secondary vehicle 130. For example, the driver or occupant of the secondary vehicle may manually accept or reject the communication request through the communication application 160. In other embodiments, the communication application 160 may automatically accept or reject requests based upon predefined user preferences, approved VCI categories, whitelists, blacklists, user-defined rules, vehicle operating conditions, or other criteria. In still further embodiments, the secondary vehicle 130 may initially display information regarding the communication request, such as the reason for the request, the detected VCI, a shared interest, a common destination, an event affiliation, or another basis for the proposed communication session before allowing the user to approve or deny the request.

FIG. 9B illustrates an embodiment in which one or more interim checks 920 are performed before, after, or in conjunction with the approval or denial action 915. The interim checks 920 may be performed by the communication applications 160 associated with the participating vehicles, by the remote service 120, or by a combination thereof. In some embodiments, the interim checks 920 may determine whether a communication session should be permitted, restricted, delayed, modified, or denied before a transient virtual chatroom is established.

For example, the interim checks 920 may include security-related validations. Such validations may verify user identities, device identities, account credentials, digital certificates, encryption capabilities, cryptographic keys, authentication tokens, multi-factor authentication status, subscription status, account standing, or other security credentials. Vehicles, devices, or users that fail one or more security validations may be prevented from participating in the communication session.

In some embodiments, the interim checks 920 may include historical interaction evaluations. For example, the communication application 160 or remote service 120 may determine whether the users previously communicated, whether prior communications resulted in blocking actions, whether one party previously reported the other party, whether prior interactions were rated positively or negatively, whether harassment or abuse reports exist, or whether one or more users have exceeded communication limits. Historical interaction data may therefore be utilized to improve user safety and communication quality.

The interim checks 920 may further include system compatibility validations. For example, the system may determine whether the communication applications 160 are compatible versions, whether the devices support the requested communication format, whether sufficient network connectivity exists, whether bandwidth thresholds are satisfied, whether location services are functioning, whether required permissions have been granted, or whether the participating devices support desired communication features such as voice, video, text, image sharing, or real-time messaging.

Additional interim checks 920 may evaluate user preferences and communication policies. For example, the system may determine whether the requested communication falls within user-defined communication settings, whether communication requests are currently permitted while driving, whether parental controls are enabled, whether geographic restrictions apply, whether time-of-day restrictions apply, whether communication limits have been reached, whether a user has elected to receive communications only from verified users, or whether the detected VCI satisfies minimum confidence thresholds established by the user or system.

In further embodiments, the interim checks 920 may include trust and reputation evaluations. For example, the remote service 120 may maintain trust scores, reputation scores, communication ratings, verification levels, participation histories, fraud indicators, or risk assessments associated with vehicles, devices, or users. The communication request may be approved, restricted, or denied based upon such trust-related information. Similarly, artificial intelligence systems may analyze communication patterns, behavioral indicators, prior interactions, account activity, and other factors to identify suspicious, fraudulent, abusive, automated, or otherwise undesirable communication attempts.

Accordingly, the interim checks 920 may serve as one or more authentication, authorization, validation, compatibility, security, trust, safety, and policy enforcement mechanisms before a communication session is established. Only after the applicable interim checks 920 have been successfully completed may the participating vehicles proceed with the generation of the transient virtual chatroom and associated communication session.

In some embodiments, the initial detection of a secondary vehicle having a matching or sufficiently related vehicle communication identifier (VCI) may merely qualify the secondary vehicle for further evaluation rather than automatically establishing a communication session. For example, a primary vehicle may detect that a secondary vehicle possesses a VCI characteristic that satisfies one or more communication criteria, such as a particular vehicle type, vehicle make, vehicle model, vehicle color, license plate characteristic, decal, insignia, organization affiliation, club membership, geographic indicator, or other detectable attribute. Upon detecting such a qualifying VCI, the system may proceed to one or more additional evaluations before determining whether the communication session should ultimately be established.

The additional evaluations may analyze one or more secondary VCIs, supplemental vehicle characteristics, user-defined preferences, historical interaction information, trust metrics, behavioral indicators, compatibility rules, or communication policies. For example, although a secondary vehicle may initially satisfy a first VCI criterion that would otherwise permit communication, the communication request may nevertheless be automatically denied if another detected VCI corresponds to a user-defined unauthorized parameter within a category, blocked parameter, excluded parameter, or incompatible parameter. By way of example, a user may desire communications with vehicles displaying a particular sports team insignia while simultaneously excluding vehicles displaying competing sports team insignias. Similarly, a user may permit communications with vehicles associated with a particular organization, club, cause, political affiliation, social interest, geographic region, profession, hobby, or demographic grouping while excluding communications associated with one or more other categories.

In some embodiments, the communication application 160 and/or remote service 120 may evaluate prior interactions between the parties before authorizing a communication session. For example, a secondary vehicle may satisfy one or more VCI matching requirements but may nevertheless be denied if the users previously blocked one another, reported one another, assigned negative interaction ratings, exceeded communication thresholds, generated harassment reports, participated in prior undesirable interactions, or otherwise triggered one or more trust or safety rules. Accordingly, a detected VCI match may serve only as an initial qualification mechanism, while historical interaction data may serve as a secondary filtering mechanism that determines whether the communication request ultimately proceeds.

In further embodiments, multiple VCIs may be evaluated simultaneously and weighted differently during the approval process. For example, a first VCI may positively contribute toward establishing a communication session, while a second VCI may negatively contribute toward the approval determination. The communication application 160 or remote service 120 may assign scores, weights, priorities, confidence levels, penalties, or compatibility ratings to individual VCIs and determine whether an aggregate threshold has been satisfied. As a result, a secondary vehicle that initially appears eligible for communication based upon one detected VCI may ultimately be rejected due to one or more conflicting VCIs, user preferences, compatibility rules, trust evaluations, safety policies, reputation metrics, or other authorization criteria.

Accordingly, in some embodiments, VCI matching may occur in multiple stages, wherein an initial VCI match identifies candidate vehicles for potential communication and one or more subsequent authorization evaluations determine whether the communication session should be approved, restricted, modified, delayed, or denied before generation of the transient virtual chatroom and associated temporary communication identifier (TCID).

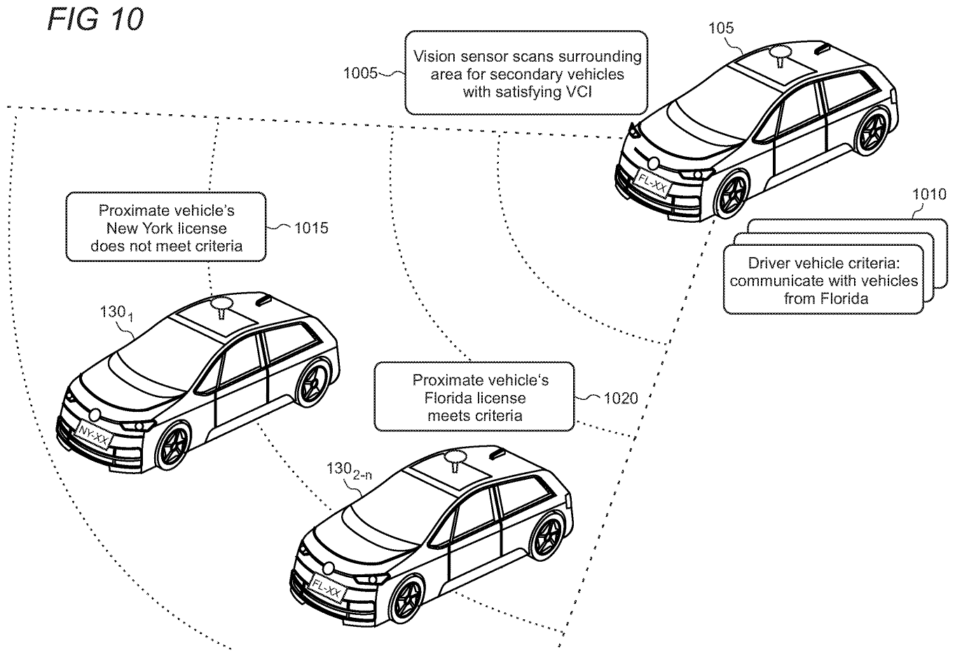

FIG. 10 shows an illustrative representation in which the primary vehicle 105 utilizes one or more vision sensors 110 to scan a surrounding environment for secondary vehicles 130 having detectable vehicle characteristic identifiers (VCI) that satisfy one or more communication criteria. As discussed above, the vision sensors 110 may include cameras, imaging systems, computer vision systems, optical character recognition systems, artificial intelligence engines, or combinations thereof configured to detect, identify, and analyze characteristics associated with nearby vehicles.

In the illustrated example, the primary vehicle 105 has established a detectable VCI corresponding to license plates originating from the State of Florida, as representatively illustrated by reference numeral 1010. During operation, the vision sensor 110 captures images of nearby vehicles and analyzes the corresponding license plates to determine whether they satisfy the configured VCI criteria. As shown, the system identifies a first secondary vehicle displaying a New York license plate and determines that the detected license plate does not satisfy the configured communication criteria. Accordingly, the communication application 160 may ignore the vehicle, discontinue further processing, deprioritize the vehicle, or otherwise refrain from initiating a communication session.

The system further identifies another secondary vehicle displaying a Florida license plate. Because the detected license plate satisfies the configured VCI criteria, the communication application 160 may proceed with one or more subsequent communication-related operations. For example, the communication application 160 may generate a communication request, initiate a handshake protocol, establish a transient virtual chatroom 155, generate a temporary communication identifier (TCID), perform participant validation procedures, authenticate users, exchange communication preferences, or execute other communication workflows described herein.

In some embodiments, license plate information may be utilized as a standalone VCI or may be combined with one or more additional VCI categories. For example, the communication application 160 may require that a secondary vehicle possess both a Florida license plate and another characteristic, such as a particular vehicle type, vehicle color, sports team affiliation, destination, route similarity, commercial affiliation, or other detectable vehicle characteristic identifier. The communication application 160 may further apply confidence thresholds, ranking algorithms, weighted scoring systems, artificial intelligence models, or user-defined preference rules when evaluating detected license plate information.

Although FIG. 10 illustrates state-specific license plate detection as an example, the disclosed embodiments are not so limited. In other embodiments, the detectable license plate information may include country of registration, county information, specialty license plates, military plates, veteran plates, university-affiliated plates, charitable organization plates, personalized or vanity plates, commercial vehicle registrations, fleet identifiers, government registrations, temporary registrations, or other information that may be detected, inferred, or obtained from the license plate. Such information may be utilized independently or in combination with other detectable VCI to determine whether communication opportunities should be initiated between proximate vehicles.

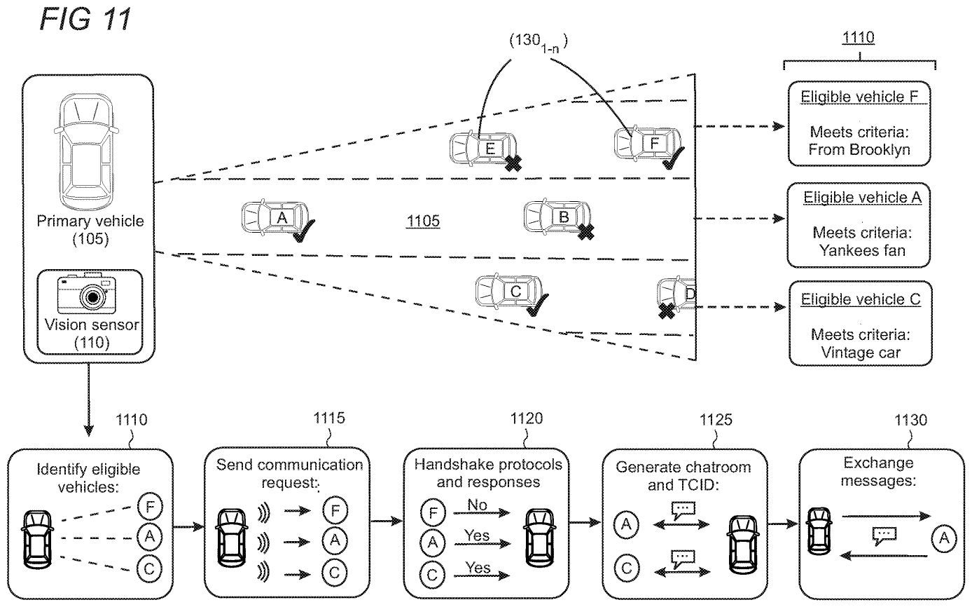

FIG. 11 shows an illustrative representation in which the primary vehicle 105 utilizes one or more vision sensors 110 to identify and analyze multiple nearby vehicles while traveling on a roadway. As discussed above, the vision sensors 110 may continuously monitor the surrounding environment and detect vehicles located within a threshold proximity of the primary vehicle. The detected vehicles may then be evaluated based upon one or more configured VCI criteria and other communication parameters.

In the illustrated example, the vision sensor 110 identifies multiple vehicles within its field of view. Following proximity analysis and VCI evaluation, the communication application 160 determines that vehicles F, A, and C satisfy the applicable communication criteria, as represented by reference numeral 1110. The remaining detected vehicles may be excluded from further processing because they do not satisfy the required proximity thresholds, VCI criteria, confidence thresholds, communication preferences, security requirements, or other eligibility requirements discussed above. Accordingly, vehicles F, A, and C are identified as eligible communication candidates.

Following identification of the eligible vehicles 1110, the primary vehicle 105 may transmit one or more communication requests 1115 to the identified vehicles. In some embodiments, separate communication requests may be transmitted to each eligible vehicle, while in other embodiments, a common communication request may be transmitted to multiple vehicles for participation in a shared communication session. The communication requests may include information such as the basis for the connection request, detected VCI information, participant information, authentication information, session parameters, provisional TCIDs, or other communication-related information.

Upon transmission of the communication requests, the participating vehicles may execute handshake protocols and responses 1120. As discussed above with respect to FIGS. 4, 5, 9A, and 9B, the handshake protocols may include participant approvals, automated acceptance procedures, security validations, authentication procedures, compatibility checks, trust evaluations, communication preference determinations, and other authorization-related processes. In some embodiments, each vehicle may independently approve or reject participation, such that some vehicles may ultimately join the communication session while others may decline or otherwise fail the handshake process.

Following successful completion of the handshake protocols, the communication application 160 and/or remote service 120 may generate a transient virtual chatroom 155 and an associated temporary communication identifier (TCID), as represented by reference numeral 1125. In some embodiments, a single chatroom and corresponding TCID may be generated for all approved participants, thereby creating a multi-vehicle communication session. In other embodiments, separate chatrooms and separate TCIDs may be generated for individual vehicles or subsets of participating vehicles. The generated TCID may uniquely identify the communication session and facilitate participant management, message routing, security enforcement, session tracking, and other communication-related functions.

Once the communication session has been established, the participating vehicles may exchange messages 1130 through the transient virtual chatroom 155. The exchanged communications may include text messages, voice communications, audio clips, images, navigation information, alerts, reactions, status updates, vehicle-generated notifications, safety-related information, entertainment content, or other forms of data. The communication session may remain active while the vehicles continue satisfying applicable session criteria, such as proximity requirements, user participation requirements, route similarities, event participation criteria, or other communication conditions. Accordingly, FIG. 11 illustrates how a single vehicle scan may identify multiple eligible vehicles and result in one or more communication sessions involving multiple participants.

The types of communications exchanged between participating vehicles may vary depending upon the particular VCIs that caused the communication session to be established. For example, when the communication session is initiated based upon vehicle type characteristics, such as motorcycles, bicycles, commercial trucks, recreational vehicles, emergency vehicles, or oversized vehicles, the exchanged communications may include safety-related information, intended driving maneuvers, blind spot notifications, road hazard alerts, traffic condition updates, lane change notifications, route coordination, vehicle status information, or other roadway awareness communications.

When the communication session is initiated based upon geographic characteristics, such as common states of registration, hometown affiliations, destinations, routes, travel corridors, tourist locations, event locations, or shared commuting patterns, participants may exchange travel recommendations, traffic updates, road condition information, weather alerts, destination-related information, restaurant recommendations, lodging recommendations, sightseeing suggestions, local event information, or other location-based communications. For example, two vehicles displaying Florida license plates while traveling in another state may exchange information regarding their travel destinations, vacation plans, preferred routes, or local recommendations.

When the communication session is established based upon sticker insignia, logos, team affiliations, hobbies, organizations, charities, educational institutions, military affiliations, professional affiliations, or other interest-based VCI, participants may exchange communications relating to the shared interest that triggered the connection. Examples include discussions regarding sports teams, sporting events, hobbies, outdoor activities, vehicle clubs, charitable causes, educational programs, entertainment topics, industry-related discussions, community events, product recommendations, or other common-interest subjects. For example, two vehicles displaying New York Yankees insignia may discuss recent games, player performance, team news, fantasy sports, upcoming events, or other sports-related topics.

In some embodiments, the communication session may be initiated based upon driver wellness, fatigue mitigation, or driver engagement objectives. In such cases, participants may exchange conversational messages intended to maintain alertness during extended driving periods, including casual conversation, trivia games, question-and-answer sessions, travel stories, destination discussions, entertainment recommendations, news discussions, or other interactive communications. Such communications may help reduce driver fatigue, improve attentiveness, and promote safer vehicle operation during long-distance travel.

Additional communications may include requests for assistance, emergency notifications, roadside assistance coordination, lost-item inquiries, convoy coordination, rideshare coordination, event meetups, business networking, social networking, product discussions, vehicle-related discussions, charging station information for electric vehicles, fuel availability information, parking information, vehicle maintenance recommendations, or any other information relevant to the participants and the VCI criteria that caused the communication session to be established. Accordingly, the content of the communication session may be dynamically tailored based upon the detected VCI, user preferences, environmental conditions, participant interests, vehicle characteristics, destinations, or other contextual factors associated with the participating vehicles.

In some embodiments, the communications exchanged between participating vehicles may be directly related to the specific VCI that resulted in the creation of the communication session. For example, where the VCI corresponds to a particular vehicle make, model, or trim package, participants may exchange information regarding vehicle performance, maintenance experiences, aftermarket modifications, repair recommendations, recalls, technical issues, fuel efficiency, charging experiences, product reviews, accessories, or ownership experiences. Owners of similar vehicles may discuss common issues, recommended service providers, replacement parts, software updates, or vehicle customization options.

Where the VCI corresponds to recreational or lifestyle indicators, such as camping-related stickers, fishing decals, hunting insignia, cycling affiliations, hiking organizations, boating registrations, skiing markings, pet-related markings, or travel-related indicators, participants may exchange recommendations relating to campsites, fishing locations, trails, parks, marinas, pet-friendly destinations, equipment recommendations, weather conditions, permits, local attractions, or other activity-specific information. For example, two vehicles displaying camping-related insignia may exchange information regarding campground availability, trail conditions, wildlife activity, or nearby recreational opportunities.

When communications are initiated based upon educational affiliations, alumni associations, universities, schools, fraternities, sororities, or student organizations, participants may exchange information regarding school events, alumni gatherings, sporting events, networking opportunities, educational programs, fundraising activities, career opportunities, or shared experiences associated with the educational institution.

Where the VCI corresponds to professional affiliations, industry organizations, trade groups, unions, certifications, or employer-related identifiers, the communication session may facilitate professional networking. Participants may discuss employment opportunities, industry developments, conferences, professional events, certifications, business opportunities, vendor recommendations, recruiting opportunities, partnerships, or other professional matters. For example, two vehicles displaying markings associated with healthcare professionals may exchange information regarding conferences, continuing education opportunities, healthcare regulations, or employment opportunities.

When the VCI corresponds to military service indicators, veteran affiliations, first responder designations, law enforcement affiliations, firefighter affiliations, or emergency medical service identifiers, participants may exchange information regarding veteran organizations, support services, charitable events, reunions, professional resources, emergency situations, public safety information, or shared occupational experiences.

Where the VCI relates to family-oriented indicators, such as “baby on board” signs, school-related markings, youth sports affiliations, family travel indicators, or child-related designations, participants may exchange information regarding family-friendly destinations, child safety information, educational opportunities, parenting resources, family activities, vacation recommendations, local attractions, or child-focused events.

In some embodiments, communications may be established based upon common destinations, routes, or navigation objectives. For example, vehicles traveling to the same sporting event, concert, convention, amusement park, tourist attraction, airport, hotel, campground, or business conference may exchange parking information, entrance recommendations, traffic conditions, event schedules, meeting locations, ticket availability, rideshare coordination, or venue-related information. Similarly, vehicles traveling along a common route may exchange information regarding road hazards, traffic congestion, law enforcement activity, construction zones, weather conditions, fuel availability, charging station availability, rest stops, or recommended alternate routes.

Where the VCI corresponds to electric vehicle characteristics, participants may exchange information regarding charging station locations, charger availability, charging speeds, station reliability, battery performance, charging costs, route planning, software updates, or energy consumption patterns. Likewise, owners of hybrid vehicles, commercial fleets, autonomous vehicles, or specialty vehicles may exchange information relevant to those vehicle categories.

In some embodiments, communications may be initiated based upon commercial or business-related VCI. For example, vehicles displaying company logos, contractor markings, delivery service branding, fleet identifiers, agricultural affiliations, construction affiliations, or service-industry identifiers may exchange information regarding job opportunities, project coordination, equipment availability, subcontractor recommendations, supplier information, local business opportunities, or service requests.

The communication session may also be based upon event-related VCI. For example, vehicles displaying stickers or markings associated with concerts, festivals, political events, charitable events, sporting events, trade shows, conventions, rallies, or community activities may exchange event schedules, venue information, meeting locations, attendance plans, merchandise information, transportation logistics, or social discussions relating to the event.

In further embodiments, the communication application 160 or remote service 120 may analyze the detected VCI and automatically generate conversation starters, suggested discussion topics, recommended questions, alerts, polls, surveys, introductions, or other communications likely to be relevant to the participating users. Such recommendations may be generated using predefined templates, artificial intelligence systems, historical communication data, user preferences, event information, geographic information, or combinations thereof to increase engagement and improve the usefulness of the transient virtual chatroom 155.

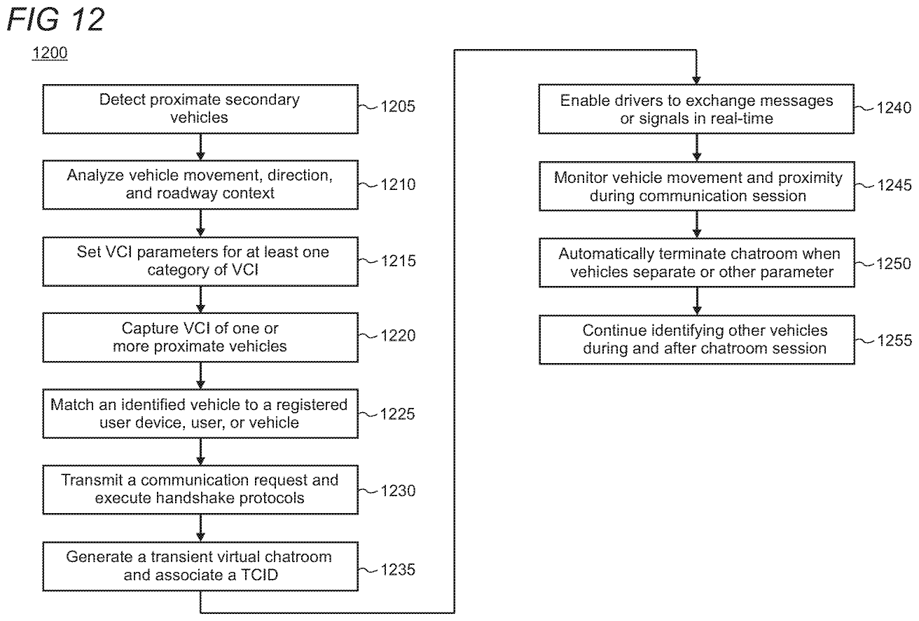

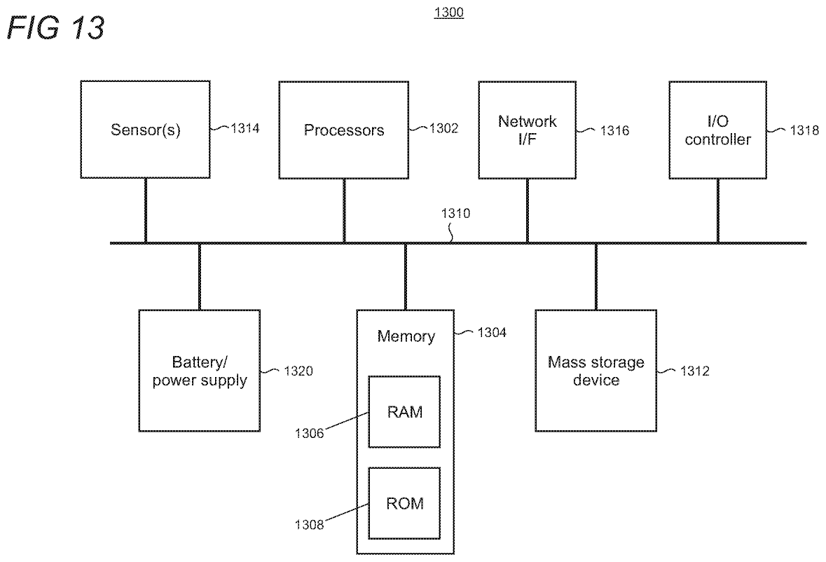

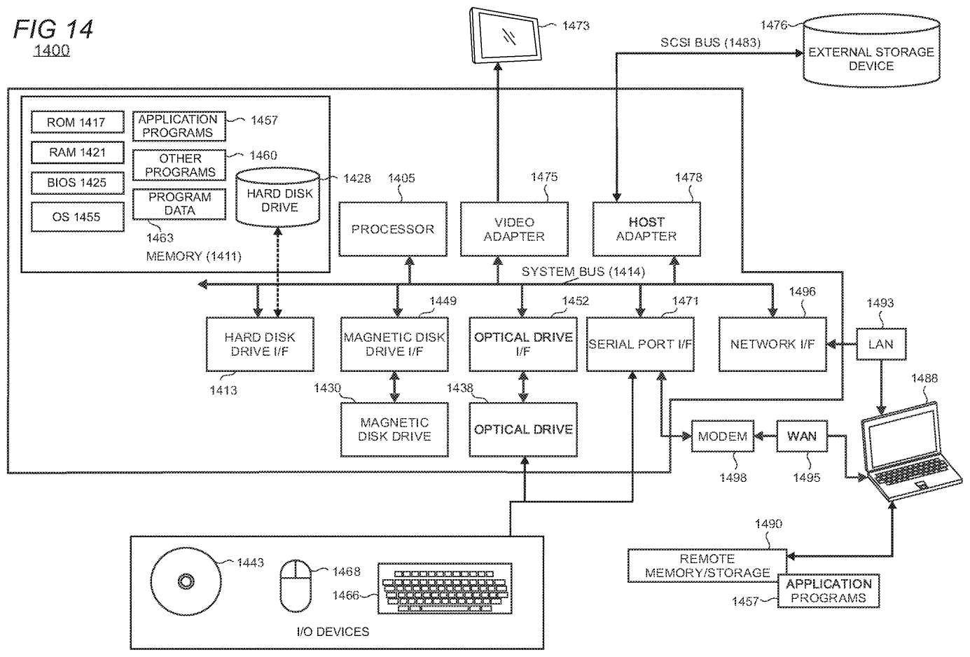

FIG. 12 shows an illustrative flowchart of processes 1200 that may be performed by one or more of the primary vehicle 105, the secondary vehicle 130, the communication applications 160, and/or the remote service 120 to establish, manage, and terminate transient communication sessions between vehicles.

In step 1205, the system detects one or more proximate secondary vehicles 130. Detection may be performed using one or more cameras, vision sensors 110, radar systems, lidar systems, ultrasonic sensors, vehicle-to-vehicle communications, location services, wireless communications, or combinations thereof. In some embodiments, the detected vehicles may initially be identified based upon their presence within a field of view of the primary vehicle 105, within a predetermined distance threshold, or within another proximity criterion.

In step 1210, the system analyzes vehicle movement, direction, and roadway context associated with the detected vehicles. For example, the communication application 160 may determine whether the vehicles are traveling in the same direction, opposite directions, adjacent lanes, merging lanes, or converging routes. The roadway context may further include determining whether the vehicles are located on highways, residential roads, city streets, parking lots, event venues, construction zones, toll roads, or other driving environments. In some embodiments, vehicle speed, acceleration, traffic density, weather conditions, route similarity, destination similarity, and other contextual factors may also be analyzed.

In step 1215, the system sets one or more VCI parameters for at least one category of VCI. As discussed above with respect to FIGS. 2 and 3, the VCI parameters may be manually established, selected from predefined profiles, generated through artificial intelligence, or otherwise configured. The VCI parameters may specify desired vehicle colors, license plate information, vehicle types, sticker insignia, distinctive markings, geographic affiliations, destinations, hobbies, organizations, sports teams, or other characteristics that may be utilized to identify candidate vehicles for communication.

In step 1220, the system captures VCI associated with one or more proximate vehicles. For example, the vision sensor 110 may capture images, video, or other sensor data corresponding to nearby vehicles. The communication application 160 may then analyze the captured information to identify license plates, vehicle colors, vehicle types, logos, decals, bumper stickers, distinctive markings, or other detectable VCI. The captured VCI may subsequently be compared against the configured VCI parameters established in step 1215.

In step 1225, the system matches an identified vehicle to a registered user device, user, or vehicle. For example, once a vehicle satisfying the VCI criteria is identified, the communication application 160 and/or remote service 120 may determine whether a corresponding registered communication account exists. Such matching may be performed using vehicle identifiers, application identifiers, communication credentials, registration records, authenticated user accounts, mobile devices, or other account information associated with the identified vehicle.

In step 1230, the system transmits a communication request and executes one or more handshake protocols. The communication request may identify the reason for the proposed communication session, the VCI that caused the connection attempt, participant information, security credentials, or other communication-related information. The handshake protocols may include user approvals, automated approvals, authentication procedures, compatibility validations, trust evaluations, security checks, communication preference checks, and other authorization procedures before permitting the communication session.

In step 1235, the system generates a transient virtual chatroom 155 and associates a temporary communication identifier (TCID) with the communication session. As discussed above, the transient virtual chatroom and TCID may be generated locally by one or more communication applications 160, remotely by the remote service 120, or through a distributed combination thereof. The TCID may uniquely identify the communication session and facilitate message routing, participant management, authentication, security enforcement, and session tracking.

In step 1240, the system enables the participating drivers and/or occupants to exchange messages or signals in real time. The communications may include text messages, voice communications, audio clips, alerts, warnings, navigation information, driving-related notifications, social communications, images, videos, vehicle-generated signals, or other forms of communication relevant to the detected VCI and communication objectives.

In step 1245, the system monitors vehicle movement and proximity during the communication session. For example, the communication application 160 and/or remote service 120 may continue tracking vehicle locations, relative distances, vehicle speeds, travel directions, route similarities, and other communication-related parameters while the transient virtual chatroom remains active.

In step 1250, the system automatically terminates the transient virtual chatroom when the vehicles separate or when another termination parameter is satisfied. Such termination parameters may include exceeding a distance threshold, diverging travel routes, expiration of a session timer, user termination, loss of communication connectivity, failure of security requirements, completion of a communication objective, or other termination conditions.

In step 1255, the system continues identifying additional vehicles during and after the communication session. Accordingly, the primary vehicle 105 may simultaneously participate in active communication sessions while continuing to identify new vehicles that satisfy proximity and VCI requirements. Additional communication requests, handshake protocols, transient virtual chatrooms, and TCIDs may therefore be generated while existing communication sessions remain active.

Although FIG. 12 illustrates an embodiment in which vehicle proximity is determined before VCI evaluation, the disclosed embodiments are not limited thereto. In some embodiments, the primary vehicle 105 may identify and connect with a secondary vehicle 130 based upon detected VCI without first performing a separate proximity determination step. For example, if the vision sensor 110, camera system, or other sensor of the primary vehicle successfully detects a license plate, sticker insignia, distinctive marking, vehicle type, vehicle color, or other VCI associated with a secondary vehicle, such detection may itself serve as evidence that the secondary vehicle is sufficiently proximate for communication purposes. Accordingly, the system may proceed directly to VCI evaluation, communication request generation, handshake protocols, chatroom creation, and TCID generation without requiring an independent proximity analysis.

In further embodiments, the communication application 160 may infer proximity based upon sensor range, image quality, confidence scores, object recognition results, radar returns, lidar measurements, communication signal strength, or combinations thereof. Thus, the order of operations shown in FIG. 12 is merely illustrative, and proximity determination, VCI detection, VCI evaluation, communication initiation, and related processes may occur in different sequences, concurrently, or be combined into one or more integrated operations.

FIG. 19 shows an illustrative diagram of a computer system that may be utilized by the vehicle's computer system to perform the operations herein, or a distinct computing device or adapter that plugs into the vehicle or otherwise is associated with the vehicle. The adapter or separate computing device may be used with the vehicle or a standalone device and application that enables the user to utilize the features herein with, for example, a legacy vehicle that may not be able to download a transient chatroom application.

The architecture 1900 illustrated in FIG. 19 includes one or more processors 1902 (e.g., central processing unit, dedicated Artificial Intelligence chip, graphics processing unit, etc.), a system memory 1904, including RAM (random access memory) 1906 and ROM (read-only memory) 1908, and a system bus 1910 that operatively and functionally couples the components in the architecture 1900. A basic input/output system containing the basic routines that help to transfer information between elements within the architecture 1900, such as during startup, is typically stored in the ROM 1908. The architecture 1900 further includes a mass storage device 1912 for storing software code or other computer-executed code that is utilized to implement applications, the file system, and the operating system. The mass storage device 1912 is connected to the processor 1902 through a mass storage controller (not shown) connected to the bus 1910. The mass storage device 1912 and its associated computer-readable storage media provide non-volatile storage for the architecture 1900. Although the description of computer-readable storage media contained herein refers to a mass storage device, such as a hard disk or CD-ROM drive, it may be appreciated by those skilled in the art that computer-readable storage media can be any available storage media that can be accessed by the architecture 1900.

By way of example, and not limitation, computer-readable storage media may include volatile and non-volatile, removable and non-removable media implemented in any method or technology for storage of information such as computer-readable instructions, data structures, program modules, or other data. For example, computer-readable media includes, but is not limited to, RAM, ROM, EPROM (erasable programmable read-only memory), EEPROM (electrically erasable programmable read-only memory), Flash memory or other solid-state memory technology, CD-ROM, DVD, HD-DVD (High Definition DVD), Blu-ray, or other optical storage, a magnetic cassette, magnetic tape, magnetic disk storage or other magnetic storage device, or any other medium which can be used to store the desired information and which can be accessed by the architecture 1900.

According to various embodiments, the architecture 1900 may operate in a networked environment using logical connections to remote computers through a network. The architecture 1900 may connect to the network through a network interface unit 1916 connected to the bus 1910. It may be appreciated that the network interface unit 1916 also may be utilized to connect to other types of networks and remote computer systems. The architecture 1900 also may include an input/output controller 1918 for receiving and processing input from a number of other devices, including a keyboard, mouse, touchpad, touchscreen, control devices such as buttons and switches, or electronic stylus (not shown in FIG. 19). Similarly, the input/output controller 1918 may provide output to a display screen, user interface, a printer, or other output device types (also not shown in FIG. 19).

It may be appreciated that the software components described herein may, when loaded into the processor 1902 and executed, transform the processor 1902 and the overall architecture 1900 from a general-purpose computing system into a special-purpose computing system customized to facilitate the functionality presented herein. The processor 1902 may be constructed from any number of transistors or other discrete circuit elements, which may individually or collectively assume any number of states. More specifically, the processor 1902 may operate as a finite-state machine in response to executable instructions contained within the software modules disclosed herein. These computer-executable instructions may transform the processor 1902 by specifying how the processor 1902 transitions between states, thereby transforming the transistors or other discrete hardware elements constituting the processor 1902.

Encoding the software modules presented herein also may transform the physical structure of the computer-readable storage media presented herein. The specific transformation of physical structure may depend on various factors in different implementations of this description. Examples of such factors may include but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

The architecture 1900 may further include one or more sensors 1914 or a battery or power supply 1920. The sensors may be coupled to the architecture to pick up data about an environment or a component, including temperature, pressure, etc. Exemplary sensors can include a thermometer, accelerometer, smoke or gas sensor, pressure sensor (barometric or physical), light sensor, ultrasonic sensor, gyroscope, among others. The power supply may be adapted with an AC power cord or a battery, such as a rechargeable battery for portability.

In light of the above, it may be appreciated that many types of physical transformations take place in the architecture 1900 in order to store and execute the software components presented herein. It also may be appreciated that the architecture 1900 may include other types of computing devices, including wearable devices, handheld computers, embedded computer systems, smartphones, PDAs, and other types of computing devices known to those skilled in the art. It is also contemplated that the architecture 1900 may not include all of the components shown in FIG. 19, may include other components that are not explicitly shown in FIG. 19, or may utilize an architecture completely different from that shown in FIG. 19.

FIG. 20 is a simplified block diagram of an illustrative computer system 2000 such as a PC (personal computer), laptop computer, the vehicle's onboard computer system, or server (such as remote service 110) with which the present transient chatrooms adapted to provide communications among drivers may be implemented.

Computer system 2000 includes a processor 2005, a system memory 2011, and a system bus 2014 that couples various system components including the system memory 2011 to the processor 2005. The system bus 2014 may be any of several types of bus structures, including a memory bus or memory controller, a peripheral bus, or a local bus using any of a variety of bus architectures. The system memory 2011 includes read-only memory (ROM) 2017 and random-access memory (RAM) 2021. A basic input/output system (BIOS) 2025, containing the basic routines that help to transfer information between elements within the computer system 2000, such as during startup, is stored in ROM 2017. The computer system 2000 may further include a hard disk drive 2028 for reading from and writing to an internally disposed hard disk (not shown), a magnetic disk drive 2030 for reading from, or writing to a removable magnetic disk 2033 (e.g., a floppy disk), and an optical disk drive 2038 for reading from or writing to a removable optical disk 2043 such as a CD (compact disc), DVD (digital versatile disc), or other optical media. The hard disk drive 2028, magnetic disk drive 2030, and optical disk drive 2038 are connected to the system bus 2014 by a hard disk drive interface 2046, a magnetic disk drive interface 2049, and an optical drive interface 2052, respectively. The drives and their associated computer-readable storage media provide non-volatile storage of computer-readable instructions, data structures, program modules, and other data for the computer system 2000. Although this illustrative example includes a hard disk, a removable magnetic disk 2033, and a removable optical disk 2043, other types of computer-readable storage media which can store data that is accessible by a computer such as magnetic cassettes, Flash memory cards, digital video disks, data cartridges, random access memories (RAMs), read-only memories (ROMs), and the like may also be used in some applications of the present transient chatrooms adapted to provide communications among drivers. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof are intended to cover non-transitory embodiments and do not include waves, signals, and/or other transitory and/or intangible communication media.

A number of program modules may be stored on the hard disk, magnetic disk 2033, optical disk 2043, ROM 2017, or RAM 2021, including an operating system 2055, one or more application programs 2057, other program modules 2060, and program data 2063. A user may enter commands and information into the computer system 2000 through input devices such as a keyboard 2066 and pointing device 2068 such as a mouse. Other input devices (not shown) may include a microphone, joystick, gamepad, satellite dish, scanner, trackball, touchpad, touchscreen, touch-sensitive device, voice-command module or device, user motion or user gesture capture device, or the like. These and other input devices are often connected to the processor 2005 through a serial port interface 2071 that is coupled to the system bus 2014 but may be connected by other interfaces, such as a parallel port, game port, or universal serial bus (USB). A monitor 2073 or other type of display device is also connected to the system bus 2014 via an interface, such as a video adapter 2075. In addition to the monitor 2073, personal computers typically include other peripheral output devices (not shown), such as speakers and printers. The illustrative example shown in FIG. 20 also includes a host adapter 2078, a Small Computer System Interface (SCSI) bus 2083, and an external storage device 2076 connected to the SCSI bus 2083.

The computer system 2000 is operable in a networked environment using logical connections to one or more remote computers, such as a remote computer 2088. The remote computer 2088 may be selected as another personal computer, a server, a router, a network PC, a peer device, or other common network node, and typically includes many or all of the elements described above relative to the computer system 2000, although only a single representative remote memory/storage device 2090 is shown in FIG. 20. The logical connections depicted in FIG. 20 include a local area network (LAN) 2093 and a wide area network (WAN) 2095. Such networking environments are often deployed, for example, in offices, enterprise-wide computer networks, intranets, and the Internet.

When used in a LAN networking environment, the computer system 2000 is connected to the local area network 2093 through a network interface or adapter 2096. When used in a WAN networking environment, the computer system 2000 typically includes a broadband modem 2098, network gateway, or other means for establishing communications over the wide area network 2095, such as the Internet. The broadband modem 2098, which may be internal or external, is connected to the system bus 2014 via a serial port interface 2071. In a networked environment, program modules related to the computer system 2000, or portions thereof, may be stored in the remote memory storage device 2090. It is noted that the network connections shown in FIG. 20 are illustrative, and other means of establishing a communications link between the computers may be used depending on the specific requirements of an application of the present transient chatrooms adapted to provide communications among drivers.

Various exemplary embodiments are disclosed herein. In one exemplary embodiment, disclosed is a computing device associated with a vehicle, the computing device adapted to enable virtual communications with other vehicle computing devices, comprising: one or more processors; an input/output (I/O) interface; and one or more hardware-based memory devices storing computer-readable instructions which, when executed by the one or more processors, cause the dialysis machine to: enter into an initial virtual chatroom inside which at least one other vehicle is a part; enable communications, through the I/O interface, to and from the at least one other vehicle, in which the communications are temporarily enabled; and based on a current driving scenario associated with the vehicle, enter into a subsequent virtual chatroom inside which at least one other vehicle is a part.

In another example, the I/O interface includes one or more of a speaker, microphone, display screen, or touchscreen. As another example, the initial and subsequent virtual chatrooms are hosted by a remote service with which the vehicle is in communication. In that example, the remote service invites the vehicle into the initial and subsequent virtual chatrooms to enable communications with other distinct vehicles. In a further example, the vehicle automatically enters at least one of the initial or subsequent virtual chatrooms responsive to receiving the remote service's invitations. In a further example, the vehicle accepts the remote service's invitation before entering at least one of the initial or subsequent chatrooms. As another example, at least one of the initial or subsequent virtual chatrooms are locally hosted on the vehicle's computer hardware, the at least one other vehicle's computer hardware, or a combination of both. In that example, the vehicle and the at least one other vehicle communicate over a short-range communication protocol. As a futher example, the short-range communication protocol includes any one or more of Bluetooth®, NFC (near field communication), or Wi-Fi. In another example, the vehicle invites the at least one other vehicle to its locally hosted virtual chatroom. In another example, each vehicle is configured to host its own virtual chatroom with other vehicles, such that either virtual chatrooms among distinct vehicles merge, or specific vehicles are invited into another vehicle's virtual chatroom. As another example, the vehicle enters virtual chatrooms using computer hardware that is part of the vehicle, or a computing device adapter that connects to the vehicle.

In another exemplary embodiment, disclosed is a method performed by a computing device associated with a vehicle, comprising: based on a current driving scenario associated with the vehicle, entering into an initial virtual chatroom inside which at least one other vehicle is a part of, in which driving scenarios include information about at least one of the vehicle's speed, proximity to other vehicles, map data, location, and forward direction; enabling communications, through the I/O interface, to and from the at least one other vehicle, in which the communications are temporarily enabled; and based on an updated driving scenario associated with the vehicle, entering into a subsequent virtual chatroom inside which at least one other vehicle is a part. In another example, the initial and subsequent virtual chatrooms are hosted by a remote service with which the vehicle is in communication. In that example, the remote service invites the vehicle into the initial and subsequent virtual chatrooms to enable communications with other distinct vehicles. As another example, the vehicle automatically enters at least one of the initial or subsequent virtual chatrooms responsive to receiving the remote service's invitations. In another example, at least one of the initial or subsequent virtual chatrooms are locally hosted on the vehicle's computer hardware, the at least one other vehicle's computer hardware, or a combination of both.

In another exemplary embodiment, disclosed is one or more hardware-based non-transitory computer-readable memory devices disposed in a medical device, the computer-readable instructions, when executed by one or more processors, cause the medical device to: based on a current driving scenario associated with the vehicle, enter into an initial virtual chatroom inside which at least one other vehicle is a part of, in which driving scenarios include information about at least one of the vehicle's speed, proximity to other vehicles, map data, location, and forward direction; enable communications, through the I/O interface, to and from the at least one other vehicle, in which the communications are temporarily enabled; and based on an updated driving scenario associated with the vehicle, enter into a subsequent virtual chatroom inside which at least one other vehicle is a part, wherein the initial and subsequent virtual chatrooms are hosted by a remote service with which the vehicle is in communication. In a further example, the vehicle enters virtual chatrooms using computer hardware that is part of the vehicle, or a computing device adapter that connects to the vehicle.

Various exemplary embodiments are disclosed herein. In an exemplary embodiment, disclosed is a computing device associated with a primary vehicle, comprising one or more processors and one or more hardware-based memory devices storing computer-readable instructions which, when executed by the one or more processors, cause the computing device to: set one or more VCI (visual communication identifiers), in which the one or more VCI includes visual characteristics of secondary vehicles; using a vision sensor and while the primary vehicle is moving, scan surrounding secondary vehicles to identify characteristics about the secondary vehicles; compare scanned characteristics with the primary vehicle's set one or more VCI; and transmit a communication request to at least one secondary vehicle that has a characteristic that satisfies the primary vehicle's one or more VCI.

In another example, the one or more VCI includes at least one of license plate information, distinctive markings or insignia on the secondary vehicles, or vehicle type. In a further example, the one or more VCI are manually set by a user of the primary vehicle. As another example, the computing device further comprises executing handshake protocols between the primary vehicle and the at least one secondary vehicle to determine whether to permit generation of and entry into a transient virtual chatroom. In another example, the handshake protocols include checking whether the one or more VCI includes exclusionary reasons for denying a communication session between the primary and secondary vehicles. In a further example, the exclusionary reasons include incompatible parameters for other categories of the one or more VCI that are different from the one or more VCI that satisfied the primary vehicle's one or more VCI. As another example, the computing device continuously scans for secondary characteristics of surrounding secondary vehicles for new communication sessions with different secondary vehicles. In another example, multiple secondary vehicles'characteristics satisfy the primary vehicle's one or more VCI, in which one of the multiple secondary vehicles accepts the communication request and one of the multiple secondary vehicles rejects the communication request.

In an exemplary embodiment, disclosed is a method comprising: setting one or more VCI (visual communication identifiers), wherein the one or more VCI includes visual characteristics of secondary vehicles; using a vision sensor and while a primary vehicle is moving, scanning surrounding secondary vehicles to identify characteristics about the secondary vehicles; comparing scanned characteristics with the primary vehicle's set one or more VCI; and transmitting a communication request to at least one secondary vehicle that has a characteristic that satisfies the primary vehicle's one or more VCI.

In another example, the one or more VCI includes at least one of license plate information, distinctive markings or insignia on the secondary vehicles, or vehicle type. In a further example, the one or more VCI are manually set by a user of the primary vehicle. As another example, the method further comprises executing handshake protocols between the primary vehicle and the at least one secondary vehicle to determine whether to permit generation of and entry into a transient virtual chatroom. In another example, the handshake protocols include checking whether the one or more VCI includes exclusionary reasons for denying a communication session between the primary vehicle and the secondary vehicle. In a further example, the exclusionary reasons include incompatible parameters for other categories of the one or more VCI that are different from the one or more VCI that satisfied the primary vehicle's one or more VCI. As another example, the method further comprises continuously scanning for secondary characteristics of surrounding secondary vehicles for new communication sessions with different secondary vehicles. In another example, characteristics of multiple secondary vehicles satisfy the primary vehicle's one or more VCI, wherein one of the multiple secondary vehicles accepts the communication request and one of the multiple secondary vehicles rejects the communication request.

In an exemplary embodiment, disclosed is one or more hardware based non-transitory computer-readable memory devices, disposed in a computing device, storing computer-executable instructions which, when executed by one or more processors, cause the computing device to: set one or more VCI (visual communication identifiers), wherein the one or more VCI includes visual characteristics of secondary vehicles; use a vision sensor and while a primary vehicle is moving, scanning surrounding secondary vehicles to identify characteristics about the secondary vehicles; compare scanned characteristics with the primary vehicle's set one or more VCI; and transmit a communication request to at least one secondary vehicle that has a characteristic that satisfies the primary vehicle's one or more VCI.

In another example, the one or more VCI includes at least one of license plate information, distinctive markings or insignia on the secondary vehicles, or vehicle type. In a further example, the one or more VCI are manually set by a user of the primary vehicle. As another example, the operations further comprise executing handshake protocols between the primary vehicle and the at least one secondary vehicle to determine whether to permit generation of and entry into a transient virtual chatroom.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computing device associated with a primary vehicle, comprising:
one or more processors;
one or more hardware-based memory devices storing computer-readable instructions which, when executed by the one or more processors, cause the computing device to:
set one or more VCI (visual communication identifiers), in which the one or more VCI includes visual characteristics of secondary vehicles;
using a vision sensor and while the primary vehicle is moving, scan surrounding secondary vehicles to identify characteristics about the secondary vehicles;
compare scanned characteristics with the primary vehicle's set one or more VCI;
transmit a communication request to at least one secondary vehicle that has a characteristic that satisfies the primary vehicle's one or more VCI.

2. The computing device of claim 1, wherein the one or more VCI includes at least one of license plate information, distinctive markings or insignia on the secondary vehicles, or vehicle type.

3. The computing device of claim 1, wherein the one or more VCI are manually set by a user of the primary vehicle.

4. The computing device of claim 1, further comprising executing handshake protocols between the primary vehicle and the at least one secondary vehicle to determine whether to permit generation of and entry into a transient virtual chatroom.

5. The computing device of claim 4, wherein the handshake protocols include checking whether the one or more VCI includes exclusionary reasons for denying a communication session between the primary and secondary vehicles.

6. The computing device of claim 5, wherein the exclusionary reasons include incompatible parameters for other categories of the one or more VCI that are different from the one or more VCI that satisfied the primary vehicle's one or more VCI.

7. The computing device of claim 1, wherein the computing device continuously scans for secondary characteristics of surrounding secondary vehicles for new communication sessions with different secondary vehicles.

8. The computing device of claim 1, wherein multiple secondary vehicles'characteristics satisfy the primary vehicle's one or more VCI, in which one of the multiple secondary vehicles accepts the communication request and one of the multiple secondary vehicles rejects the communication request.

9. A method comprising:
setting one or more VCI (visual communication identifiers), wherein the one or more VCI includes visual characteristics of secondary vehicles;
using a vision sensor and while a primary vehicle is moving, scanning surrounding secondary vehicles to identify characteristics about the secondary vehicles;
comparing scanned characteristics with the primary vehicle's set one or more VCI; and
transmitting a communication request to at least one secondary vehicle that has a characteristic that satisfies the primary vehicle's one or more VCI.

10. The method of claim 9, wherein the one or more VCI includes at least one of license plate information, distinctive markings or insignia on the secondary vehicles, or vehicle type.

11. The method of claim 9, wherein the one or more VCI are manually set by a user of the primary vehicle.

12. The method of claim 9, further comprising executing handshake protocols between the primary vehicle and the at least one secondary vehicle to determine whether to permit generation of and entry into a transient virtual chatroom.

13. The method of claim 12, wherein the handshake protocols include checking whether the one or more VCI includes exclusionary reasons for denying a communication session between the primary vehicle and the secondary vehicle.

14. The method of claim 13, wherein the exclusionary reasons include incompatible parameters for other categories of the one or more VCI that are different from the one or more VCI that satisfied the primary vehicle's one or more VCI.

15. The method of claim 9, further comprising continuously scanning for secondary characteristics of surrounding secondary vehicles for new communication sessions with different secondary vehicles.

16. The method of claim 9, wherein characteristics of multiple secondary vehicles satisfy the primary vehicle's one or more VCI, wherein one of the multiple secondary vehicles accepts the communication request and one of the multiple secondary vehicles rejects the communication request.

17. One or more hardware based non-transitory computer-readable memory devices, disposed in a computing device, storing computer-executable instructions which, when executed by one or more processors, cause the computing device to:
set one or more VCI (visual communication identifiers), wherein the one or more VCI includes visual characteristics of secondary vehicles;
use a vision sensor and while a primary vehicle is moving, scanning surrounding secondary vehicles to identify characteristics about the secondary vehicles;
compare scanned characteristics with the primary vehicle's set one or more VCI; and
transmit a communication request to at least one secondary vehicle that has a characteristic that satisfies the primary vehicle's one or more VCI.

18. The one or more hardware-based memory devices of claim 17, wherein the one or more VCI includes at least one of license plate information, distinctive markings or insignia on the secondary vehicles, or vehicle type.

19. The one or more hardware-based memory devices of claim 17, wherein the one or more VCI are manually set by a user of the primary vehicle.

20. The one or more hardware-based memory devices of claim 17, wherein the operations further comprise executing handshake protocols between the primary vehicle and the at least one secondary vehicle to determine whether to permit generation of and entry into a transient virtual chatroom.
